(19) United States
(12) Patent Application Publication
(10) Pub. No.: US 2021/0289430 A1
(43) Pub. Date: Sep. 16, 2021

(54) ELECTRONIC DEVICE AND METHOD FOR CONTROLLING SAME

(71) Applicant: SAMSUNG ELECTRONICS CO., LTD., Suwon-si, Gyeonggi-do (KR)

(72) Inventors: Sunmin HWANG, Suwon-si, Gyeonggi-do (KR); Soomin LEE, Suwon-si, Gyeonggi-do (KR); Hongju PARK, Suwon-si, Gyeonggi-do (KR); Suyoung PARK, Suwon-si, Gyeonggi-do (KR)

(21) Appl. No.: 17/258,685

(22) PCT Filed: Jul. 10, 2019
(86) PCT No.: PCT/KR2019/008479

§ 371 Date: Jan. 7, 2021

(30) Foreign Application Priority Data
Jul. 13, 2018 (KR) 10-2018-0081653

(51) Int. Cl. H04W 48/16; H04W 60/00; H04W 48/18; H04W 48/08

(52) U.S. Cl. CPC H04W 48/16; H04W 48/08; H04W 48/18; H04W 60/00

(57) ABSTRACT

The present disclosure relates to a 5G or pre-5G communication system for supporting higher data transmission rate beyond a 4G communication system such as LTE. According to various embodiments disclosed in the present document, an electronic device comprises: a touch screen display; at least one communication processor configured so as to provide first wireless communication using a first frequency range and second wireless communication using a second frequency range higher than the first frequency range; an application processor operatively connected to the display and at least one communication processor; and at least one memory operatively connected to the communication processor and/or the application processor and configured so as to store network selection information. The memory can store instructions which enable, during execution, at least one communication processor to receive information items relating to a plurality of cells from at least one of the plurality of cells related to the first wireless communication, by means of the first wireless communication, select one cell among the plurality of cells on the basis of at least a part of the information items related to the plurality of cells, identify whether or not the selected cell is connected to a first core network and a second core network on the basis of at least a part of the information related to the selected cell, and transmit, to one core network among the first core network and the second core network, a registration request message for using the one core network by means of the first wireless communication on the basis of at least a part of the stored network selection information.

### TECHNICAL FIELD

Various embodiments described in the disclosure relate to a wireless communication system and, more particularly, to a method of using a network by an electronic device in a network structure in which 4G communication and 5G communication are mixed.

### BACKGROUND ART

To meet the demand for wireless data traffic having increased since deployment of 4G communication systems, efforts have been made to develop an improved 5G or pre-5G communication system. Therefore, the 5G or pre-5G communication system is also called a “Beyond 4G Network” or a “Post LTE System”.

The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G communication systems

### DISCLOSURE OF INVENTION

### Technical Problem

Each of the 4G communication system, 5G communication system, or pre-5G communication system may provide at least one of a wireless communication interface or service differently. In a network structure in which several communication systems are mixed, a network connection method of an electronic device may be required.

According to various embodiments disclosed in this document, the electronic device may be connected to a 4G or 5G network, based on at least one of wireless communication priority (e.g., radio access technology priority (RAT priority)) or network selection information including at least a core network preference.

### Solution to Problem

An electronic device according to various embodiments disclosed in the document may include a touch screen display, at least one communication processor configured to provide a first wireless communication using a first frequency range and a second wireless communication using a second frequency range higher than the first frequency range, an application processor operatively connected to the display and the at least one communication processor, and at least one memory operatively connected to the communication processor and/or the application processor, and configured to store network selection information, wherein the memory may store instructions which enable, when executed, the at least one communication processor to: receive information related to the plurality of cells from at least one of the plurality of cells related to the first wireless communication using the first wireless communication; select one cell among the plurality of cells, based on at least some of the information related to the plurality of cells; identify whether the selected cell is connected to a first core network and a second core network, based on at least part of the information related to the selected cell; and transmit a registration request message for use of the one core network to one of the first core network or the second core network using the first wireless communication, based at least in part on the stored network selection information.

A control method of an electronic device according to various embodiments disclosed in the document may include: receiving information related to a plurality of cells from at least one of the plurality of cells related to a first wireless communication using the first wireless communication, by at least one communication processor configured to provide the first wireless communication using a first frequency range and a second wireless communication using a second frequency range higher than the first frequency range; selecting one of the plurality of cells, based on at least some pieces of the information related to the plurality of cells; identifying whether the selected cell is connected to a first core network and a second core network, based on at least part of the information related to the selected cell; and transmit a registration request message for use of the one core network to one of the first core network and the second core network by using the first wireless communication, based at least in part on the stored network selection information.

### Advantageous Effects of Invention

An electronic device according to various embodiments of the disclosure can be connected to a 4G or 5G network, based on at least one of wireless communication priority or core network preference of the electronic device in a network structure in which 4G communication and 5G communication are mixed.

### BRIEF DESCRIPTION OF DRAWINGS

FIG. 1 is a block diagram of an electronic device in a network environment, according to various embodiments;

FIG. 2 is a diagram illustrating a 5G network architecture according to various embodiments;

FIG. 3A is a diagram illustrating a structure of an LTE network according to various embodiments;

FIG. 3B is a diagram illustrating a radio protocol structure in an LTE network according to various embodiments;

FIG. 3C is a diagram illustrating a structure of a 5G network according to various embodiments;

FIG. 3D is a diagram illustrating a structure of a control plane protocol of a 5G network according to various embodiments;

FIG. 3E is a diagram illustrating a user plane protocol structure of a 5G network according to various embodiments;

FIGS. 4A to 4G are diagrams illustrating a network structure in which at least some of 4G network and 5G network are mixed according to various embodiments;

FIG. 5 is a table showing wireless communication priorities and a non-access stratum (NAS) procedure available in an electronic device according to a combination of communication network arrangement options according to various embodiments;

FIG. 6 is a diagram illustrating a UI for controlling activation of an application requesting a 5G service in an electronic device according to various embodiments;

FIGS. 7 and 8 are flowcharts illustrating methods of connecting an electronic device to a 4G network or a 5G network according to various embodiments;

FIG. 9 is a diagram illustrating a network arrangement according to various embodiments;

FIGS. 10A and 10B are diagrams illustrating a network arrangement according to various embodiments disclosed in this document;

FIG. 11 is a block diagram illustrating a structure of an electronic device according to various embodiments; and

FIG. 12 is a flowchart illustrating a method of controlling an electronic device according to various embodiments.

### MODE FOR THE INVENTION

In the following description, terms for identifying access nodes, terms referring to network entities, terms referring to messages, terms referring to interfaces between network entities, terms referring to various identification information, and the like are illustratively used for the sake of convenience. Therefore, the disclosure is not limited by the terms as used below, and other terms referring to subjects having equivalent technical meanings may be used.

In the following description, the disclosure will be described using terms and names defined in the 3rd generation partnership project (3GPP) standards for the convenience of description. However, the disclosure is not limited by these terms and names, and may be applied in the same way to systems that conform other standards.

A brief description will be given of a structure of a 5G network (or a next generation network) that can be applied according to various embodiments disclosed in this document. The 5G network may include a 5G wireless network and a 5G core network. The 5G wireless network (or radio access network) may include a new radio (NR) base station (e.g., NR Node B, NR gNB). According to an embodiment, an electronic device (e.g., user terminal, NR UE, terminal) may access an external network (e.g., an application server) through a 5G network.

According to various embodiments disclosed in this document, the NR base station may provide at least some of the functions provided by the evolved node B (eNB) of the LTE network (or 4G network). For example, the NR base station may be connected to the electronic device through a radio channel. The NR base station may manage channel allocation by receiving status information such as a buffer status, an available transmission power status, and a channel status of electronic devices.

According to various embodiments, the 5G core network may perform functions such as mobility support, bearer configuration, and QoS configuration. The 5G core network may perform various control functions such as mobility management functions and/or authentication for electronic devices, and may be connected to a plurality of base stations.

According to various embodiments, the 5G network may interwork with the LTE network. For example, a 5G network may be connected to an LTE core network (evolved packet core (EPC)) (e.g., MME) through a network interface.

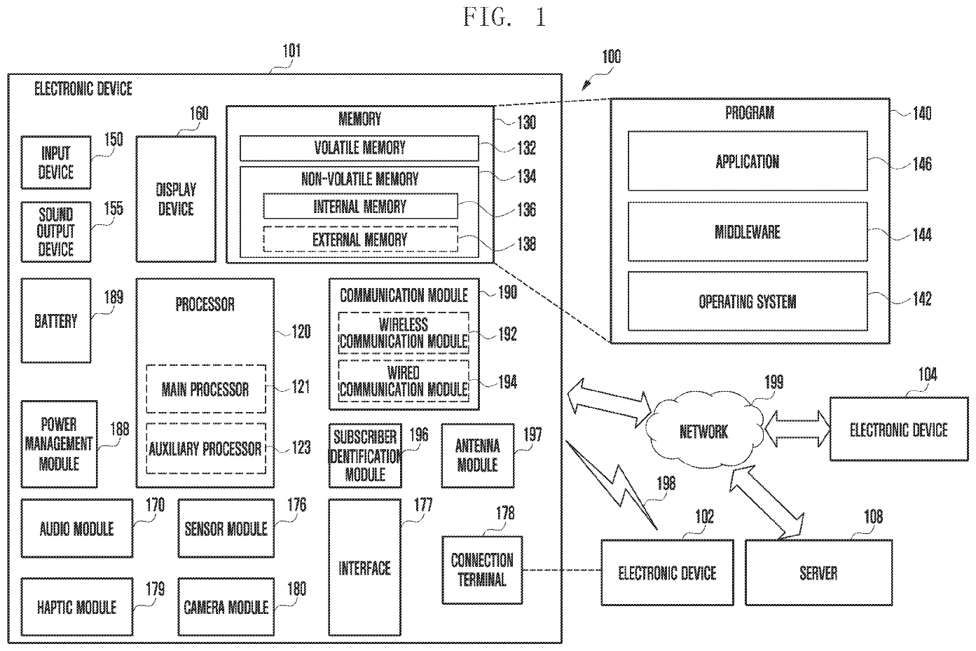

FIG. 1 is a block diagram of an electronic device in a network environment, according to various embodiments.

Referring to FIG. 1, the electronic device 101 in a network environment 100 may communicate with an electronic device 102 through a first network 198 (e.g., a short-range wireless communication network), or may communicate with an electronic device 104 or a server 108 through a second network 199 (e.g., a long-distance wireless communication network). According to an embodiment, the electronic device 101 may communicate with the electronic device 104 through the server 108. According to an embodiment, the electronic device 101 may include a processor 120, a memory 130, an input device 150, an audio output device 155, a display device 160, an audio module 170, a sensor module 176, an interface 177, a haptic module 179, a camera module 180, a power management module 188, a battery 189, a communication module 190, a subscriber identification module 196, or an antenna module 197. In some embodiments, at least one of these components (e.g., the display device 160 or the camera module 180) may be omitted or one or more other components may be added to the electronic device 101. In some embodiments, some of these components may be implemented as one integrated circuit. For example, the sensor module 176 (e.g., a fingerprint sensor, an iris sensor, or an illuminance sensor) may be implemented while being embedded in the display device 160 (e.g., a display).

According to various embodiments, the processor 120, for example, executes software (e.g., a program 140) to control at least one other component (e.g., hardware or software component) of the electronic device 101 connected to the processor 120, and may perform various data processing or operations. According to an embodiment, as at least a part of data processing or operation, the processor 120 may load commands or data received from another component (e.g., the sensor module 176 or the communication module 190) into the volatile memory 132, process commands or data stored in the volatile memory 132, and may store result data in the nonvolatile memory 134. According to an embodiment, the processor 120 includes a main processor 121 (e.g., a central processing unit or an application processor), and a secondary processor 123 (e.g., a graphics processing device, an image signal processor, a sensor hub processor, or a communication processor) that can be operated independently or together therewith. Additionally or alternatively, the secondary processor 123 may be configured to use lower power than the main processor 121 or to be specialized for a designated function. The secondary processor 123 may be implemented separately from the main processor 121 or as a part thereof.

According to various embodiments, the secondary processor 123 may control at least some of the functions or states related to at least one of the components of the electronic device 101 (e.g., the display device 160, the sensor module 176, or the communication module 190), for example, on behalf of the main processor 121 while the main processor 121 is in an inactive (e.g., sleep) state, or with the main processor 121 while the main processor 121 is in an active (e.g., application execution) state. According to an embodiment, the secondary processor 123 (e.g., an image signal processor or a communication processor) may be implemented as a part of other functionally related components (e.g., the camera module 180 or the communication module 190).

According to various embodiments, the memory 130 may store various data used by at least one component of the electronic device 101 (e.g., the processor 120 or the sensor module 176). The data may include, for example, software (e.g., the program 140) and input data or output data for commands related thereto. The memory 130 may include a volatile memory 132 or a nonvolatile memory 134.

According to various embodiments, the program 140 may be stored as software in the memory 130, and may include, for example, an operating system 142, middleware 144, or an application 146.

According to various embodiments, the input device 150 may receive commands or data to be used for components of the electronic device 101 (e.g., the processor 120) from the outside (e.g., a user) of the electronic device 101. The input device 150 may include, for example, a microphone, a mouse, or a keyboard.

According to various embodiments, the audio output device 155 may output an audio signal to the outside of the electronic device 101. The audio output device 155 may include, for example, a speaker or a receiver. The speaker may be used for general purposes such as multimedia playback or recording playback, and the receiver may be used to receive incoming calls. According to an embodiment, the receiver may be implemented separately from or as a part of the speaker.

According to various embodiments, the display device 160 may visually provide information to the outside (e.g., a user) of the electronic device 101. The display device 160 may include, for example, a display, a hologram device, or a projector and a control circuit for controlling the device. According to an embodiment, the display device 160 may include a touch circuitry configured to sense a touch, or a sensor circuit (e.g., a pressure sensor) configured to measure the strength of a force generated by the touch.

According to various embodiments, the audio module 170 may convert sound into an electric signal, or conversely, convert an electric signal into sound. According to an embodiment, the audio module 170 may acquire sound through the input device 150, or output sound through the audio output device 155 or an external electronic device (e.g., the electronic device 102) (e.g., speaker or headphones) directly or wirelessly connected to the electronic device 101.

According to various embodiments, the sensor module 176 detects an operating state (e.g., power or temperature) of the electronic device 101 or an external environment state (e.g., a user state), and generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

According to various embodiments, the interface 177 may support one or more designated protocols that may be used to connect the electronic device 101 directly or wirelessly to an external electronic device (e.g., the electronic device 102). According to an embodiment, the interface 177 may include, for example, a high definition multimedia interface (HDMI), a universal serial bus (USB) interface, an SD card interface, or an audio interface.

According to various embodiments, the connection terminal 178 may include a connector through which the electronic device 101 can be physically connected to an external electronic device (e.g., the electronic device 102). According to an embodiment, the connection terminal 178 may include, for example, an HDMI connector, a USB connector, an SD card connector, or an audio connector (e.g., a headphone connector).

According to various embodiments, the haptic module 179 may convert an electrical signal into a mechanical stimulus (e.g., vibration or movement) or an electrical stimulus that a user can perceive through a tactile or motor sense. According to an embodiment, the haptic module 179 may include, for example, a motor, a piezoelectric element, or an electrical stimulation device.

According to various embodiments, the camera module 180 may capture a still image and a video. According to an embodiment, the camera module 180 may include one or more lenses, image sensors, image signal processors, or flashes.

According to various embodiments, the power management module 188 may manage power supplied to the electronic device 101. According to an embodiment, the power management module 388 may be implemented as at least a part of a power management integrated circuit (PMIC), for example.

According to various embodiments, the battery 189 may supply power to at least one component of the electronic device 101. According to an embodiment, the battery 189 may include, for example, a non-rechargeable primary cell, a rechargeable secondary cell, or a fuel cell.

According to various embodiments, the communication module 190 may support establishing a direct (e.g., wired) communication channel or a wireless communication channel between the electronic device 101 and an external electronic device (e.g., the electronic device 102, the electronic device 104, or the server 108), and performing communication through the established communication channel. The communication module 190 operates independently of the processor 120 (e.g., an application processor) and may include one or more communication processors that support direct (e.g., wired) communication or wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication module). Among these communication modules, a corresponding communication module may communicate with an external electronic device through a first network 198 (e.g., a short-range communication network such as Bluetooth, WiFi direct, or infrared data association (IrDA)) or a second network 199 (e.g., a long-distance communication network such as cellular network, Internet, or a computer network (e.g., LAN or WAN)). These various types of communication modules may be integrated into a single component (e.g., a single chip), or may be implemented with a plurality of separate components (e.g., multiple chips). The wireless communication module 192 may identify and authenticate the electronic device 101 in a communication network such as the first network 198 or the second network 199 using subscriber information (e.g., international mobile subscriber identifier (IMSI)) stored in the subscriber identification module 196.

According to various embodiments, the antenna module 197 may transmit a signal or power to the outside (e.g., an external electronic device) or receive from the outside. According to an embodiment, the antenna module 197 may include one or more antennas. From this, at least one antenna suitable for a communication method used in a communication network such as the first network 198 or the second network 199 may be selected by, for example, the communication module 190. The signal or power may be transmitted or received between the communication module 190 and an external electronic device through the at least one selected antenna.

According to various embodiments, at least some of the components may be connected to each other through a communication method (e.g., bus, general purpose input and output (GPIO), serial peripheral interface (SPI), or mobile industry processor interface (MIPI)) between peripheral devices, and signals (e.g., commands or data) may be exchanged with each other.

According to various embodiments, the command or data may be transmitted or received between the electronic device 101 and the external electronic device 104 through the server 108 connected to the second network 199. Each of the electronic devices 102 and 104 may be a device of the same or different type as the electronic device 101. According to an embodiment, all or part of the operations executed by the electronic device 101 may be executed by one or more of the external electronic devices 102, 104, or 108. For example, when the electronic device 101 needs to perform a function or service automatically or in response to a request from a user or another device, the electronic device 101 may request one or more external electronic devices to perform the function or at least part of the service instead of or in addition to executing the function or service by itself. One or more external electronic devices receiving the request may execute at least a part of the requested function or service, or an additional function or service related to the request, and transmit a result of the execution to the electronic device 101. The electronic device 101 may process the result as it is or additionally and provide the same as at least a part of a response to the request. For this, for example, cloud computing, distributed computing, or client-server computing technology may be used.

The electronic device according to various embodiments may be one of various types of electronic devices. The electronic devices may include, for example, a portable communication device (e.g., a smart phone), a computer device, a portable multimedia device, a portable medical device, a camera, a wearable device, or a home appliance. The electronic device according to embodiments of the disclosure is not limited to those described above.

It should be appreciated that various embodiments of the disclosure and the terms used therein are not intended to limit the technological features set forth herein to particular embodiments and include various changes, equivalents, and/or alternatives for a corresponding embodiment. With regard to the description of the drawings, similar reference numerals may be used to designate similar or relevant elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “a first”, “a second”, “the first”, and “the second” may be used to simply distinguish a corresponding element from another, and does not limit the elements in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may be interchangeably used with other terms, for example, “logic,” “logic block,” “component,” or “circuit”. The “module” may be a minimum unit of a single integrated component adapted to perform one or more functions, or a part thereof. For example, according to an embodiment, the “module” may be implemented in the form of an application-specific integrated circuit (ASIC).

Various embodiments as set forth herein may be implemented as software (e.g., the program 140) including one or more instructions that are stored in a storage medium (e.g., the internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each element (e.g., a module or a program) of the above-described elements may include a single entity or multiple entities. According to various embodiments, one or more of the above-described elements may be omitted, or one or more other elements may be added. Alternatively or additionally, a plurality of elements (e.g., modules or programs) may be integrated into a single element. In such a case, according to various embodiments, the integrated element may still perform one or more functions of each of the plurality of elements in the same or similar manner as they are performed by a corresponding one of the plurality of elements before the integration. According to various embodiments, operations performed by the module, the program, or another element may be carried out sequentially, in parallel, repeatedly, or heuristically, or one or more of the operations may be executed in a different order or omitted, or one or more other operations may be added.

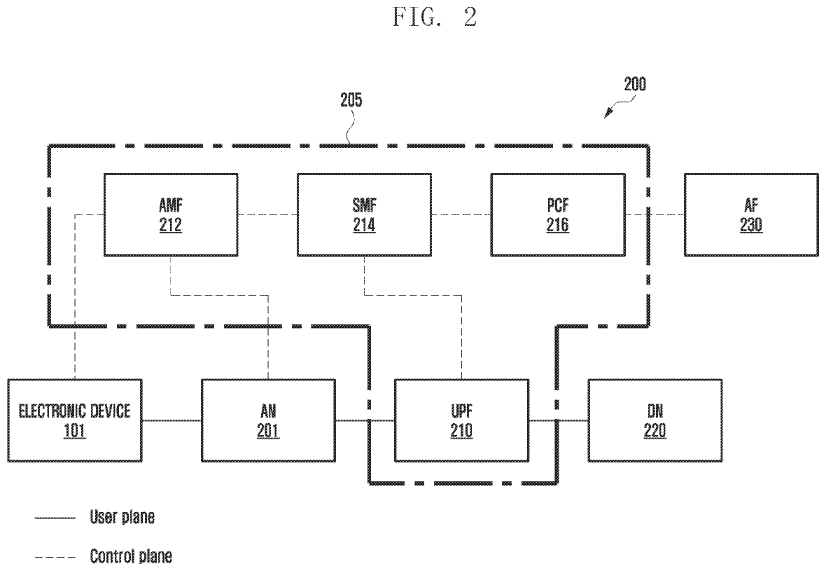

FIG. 2 is a diagram illustrating a 5G network 200 architecture according to various embodiments.

Referring to FIG. 2, the network 200 (e.g., the second network 199 of FIG. 1) may refer to a 5G network defined by ITU or 3GPP. For example, the function, structure, or arrangement of the components shown in FIG. may be implemented with reference to a technical specification (TS) 23.501. Each of the components included in the network 200 may refer to a unit of a physical entity, or a unit of software or a module capable of performing an individual function. In the network 200, a user plane may refer to a path through which a user of the electronic device 101 transmits and receives a data packet for receiving a service, and a control plane may refer to a path for transmitting and receiving a control signal for connection, management, or release of a network used for data packet transmission.

According to an embodiment, the electronic device 101 may refer to a device used by a user. The electronic device 101 may refer to, for example, a terminal, user equipment (UE), a mobile station, a subscriber station, a remote terminal, a wireless terminal, or a user device.

According to an embodiment, an access network (AN) 201 may provide a channel for wireless communication with the electronic device 101. The AN 201 may include a radio access network (RAN), a base station, an enode B (eNB), a 5G node, a transmission/reception point (TRP), or a 5th generation node B (5GNB).

According to an embodiment, a data network (DN) 220 may transmit and receive data (or data packet) to and from the electronic device 101 through a core network (CN) 205 and the AN 201 to provide a service (e.g., Internet services, IP multimedia subsystem (IMS) services).

According to an embodiment, the CN 205 may include a user plane function (UPF) node 210, an access and mobility management function (AMF) node 212, a session management function (SMF) node 214, and a policy control function (PCF) node 216. The type and number of components included in the CN 205 are not limited to the example shown in FIG. 2, and at least one of the same component (e.g., a UPF node) or another component (e.g., a unified data management (UDM) node) may be further included, or at least one component may be omitted.

According to an embodiment, the AMF node 212 and the SMF node 214 may perform the same function as the mobility management entity (MME) in a 4G network, or may perform at least some of the MME functions. For example, the AMF node 212 may manage access authorization for the CN 205 of the electronic device 101 and information related to the mobility of the electronic device 101. The SMF node 214 may generate a session for data transmission between the electronic device 101 and the DN 220 through the UPF node 210, and may control UPF re-location for changing the UPF node 210 connected to the electronic device 101.

According to an embodiment, the PCF node 216 may perform the same function as a policy control resource function (PCRF) in a 4G network, or may perform at least a part of the PCRF. For example, the PCF node 216 may determine a policy related to data transmission of the electronic device 101, based on information related to quality of service (QoS) or charging information.

According to an embodiment, the UPF node 210 may perform functions of a packet data network gateway (P-GW) and a serving gateway (S-GW) in a 4G network. For example, the UPF node 210 may perform a routing function so that data can be transmitted/received between the electronic device 101 and the DN 220 on the user plane, and may perform an anchor function of allocating an internet protocol (IP) address corresponding to the DN 220.

According to an embodiment, the application function (AF) node 230 may provide information related to QoS to the PCF node 216.

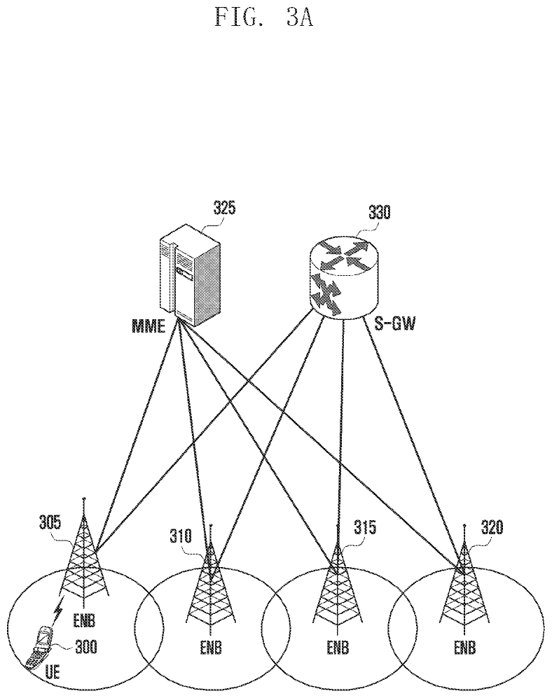

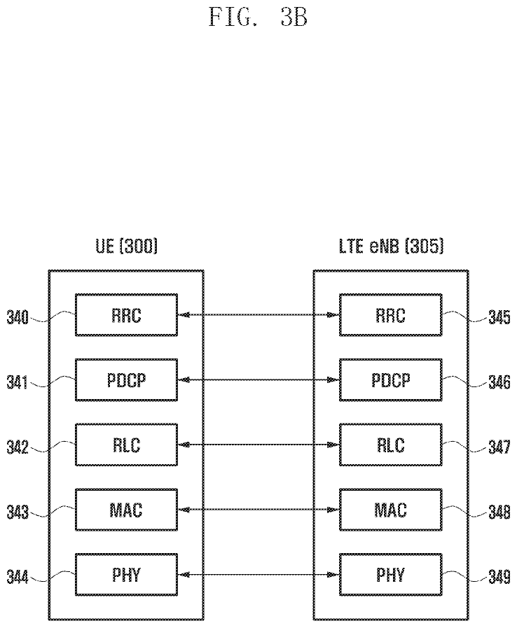

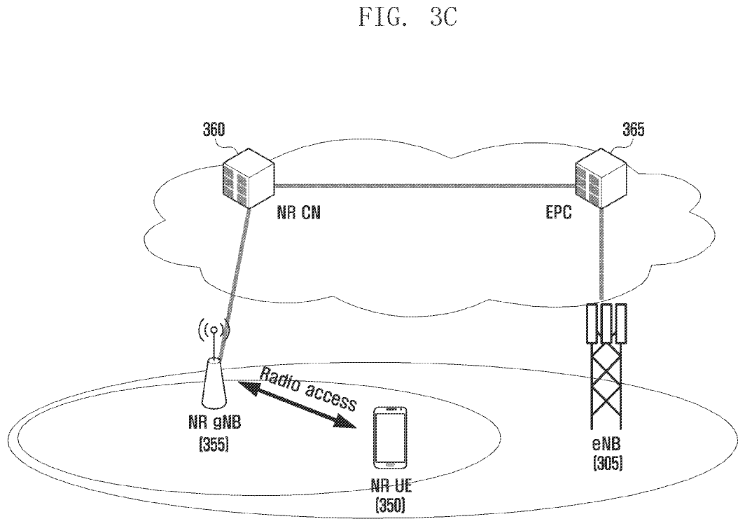

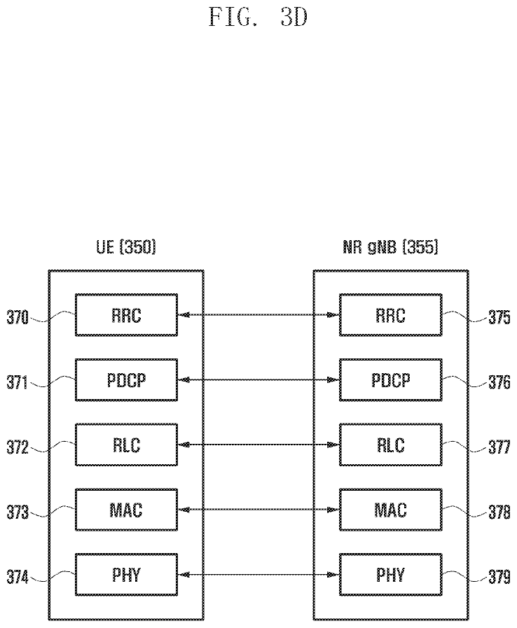

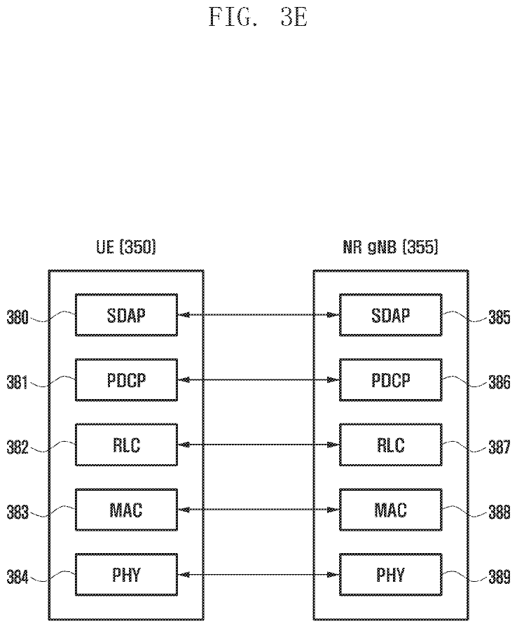

FIG. 3A is a diagram illustrating a structure of an LTE network according to various embodiments.

Referring to FIG. 3A, the LTE network (or, 4G network) according to various embodiment may include a radio access network including evolved node Bs (eNBs) 305, 310, 315, 320, and an LTE core network (hereinafter, evolved packet core (EPC)). The EPC may include a mobility management entity (MME) 325 and a Serving-Gateway (S-GW) 330. The electronic device 300 (e.g., 101 of FIG. 1) (e.g., a user equipment) may access an external network through the eNBs 305, 310, 315, and 320 and the S-GW 330.

According to various embodiments, in an LTE network, user traffic including real-time services such as VoIP (Voice over IP) through an Internet protocol may be serviced through a shared channel. The eNB may perform channel scheduling by receiving state information such as a buffer state, an available transmit power state, and a channel state of UEs.

According to various embodiments, the LTE network may use, for example, an orthogonal frequency division multiplexing (OFDM) in a 20 MHz bandwidth as a radio access technology. In addition, an adaptive modulation and coding method (hereinafter referred to as “AMC”) for determining a modulation scheme and a channel coding rate according to the channel state of the electronic device may be applied.

According to various embodiments, the S-GW 330 may provide a data bearer. The S-GW 330 may generate or remove a data bearer according to the control of the MME 325. According to various embodiments, the MME 325 is a device that performs various control functions as well as a mobility management function for an electronic device, and may be connected to a plurality of base stations.

FIG. 3B is a diagram illustrating a radio protocol structure in an LTE network according to various embodiments.

Referring to FIG. 3B, the electronic device 300 (e.g., 101 of FIG. 1) and the eNB 305 of an LTE network according to various embodiments may include a radio resource control (RRC) 340, 345, a packet data convergence protocols (PDCP) 341, 346, a radio link control (RLC) 342, 347, a medium access control (MAC) 343, 348, and a physical layer (PHY) 344, 349, respectively.

According to various embodiments, the RRCs 340 and 345 may perform at least one of, for example, system information transmission, RRC connection control, and channel measurement control.

According to various embodiments, the PDCPs 341 and 346 may perform at least one of, for example, compression/restore of IP header, data transmission, protocol data unit (PDU) sequential delivery to upper layer, data encryption and decryption, or timer-based service data unit (SDU) deduplication.

According to various embodiments, the radio link controls (hereinafter referred to as “RLC”) 342 and 347 may perform at least one of, for example, data transmission, an ARQ operation by reconfiguring a PDCP protocol data unit (PDU) by an appropriate size, splicing, splitting and reassembling RLC SDUs, deleting an RLC SDU, and re-establishing the RLC.

The MACs 343 and 348 may be connected to multiple RLC layer devices configured in one electronic device. According to various embodiments, the MACs 343 and 347 may perform at least one of, for example, multiplexing RLC PDUs to MAC PDUs and demultiplexes RLC PDUs from MAC PDUs, mapping between logical channels and transport channels, reporting of scheduling information, a hybrid automatic repeat and request (HARQ), priority adjustment between logical channels, priority level adjustment between electronic devices, multimedia broadcast multicast services (MBMS) service identification, transmission format selection and padding.

According to various embodiments, the physical layers (hereinafter referred to as “PHY”) 344 and 348 may channel-code and modulate higher layer data (e.g., an MAC PDU), make OFDM symbols, and transmit them through a wireless channel. In addition, the PHYs 344 and 348 may perform demodulating the OFDM symbol received through a radio channel, decoding the channel, and transmitting the demodulation to an upper layer.

FIG. 3C is a diagram illustrating a structure of a 5G network according to various embodiments.

Referring to FIG. 3C, 5G network according to various embodiments may include a radio access network and a core network. For example, the radio access network may include an NR base station (NR gNB) 355. The NR electronic device 350 (e.g., user equipment) (e.g., 101 of FIG. 1) may access an external network through the NR base station 355 and a 5G core network (or NR CN) 360.

According to various embodiments, the NR base station 355 in FIG. 3C may perform at least some of the same functions as the evolved node B (eNB) 305 of the LTE network. The NR base station 355 may be connected to the NR electronic device 350 through a radio channel. In the NR mobile communication system, all user traffic can be serviced through a shared channel. Accordingly, the NR base station 355 may perform channel scheduling by receiving state information such as a buffer state, an available transmit power state, and a channel state of electronic devices. The NR base station 355 may provide a wider bandwidth to implement ultra-high-speed data transmission compared to the eNB 305 and may use an orthogonal frequency division multiplexing (OFDM) method. In addition, the NR base station 355 of the 5G network may use a beamforming technique. In addition, an adaptive modulation and coding method (hereinafter referred to as “AMC”) for determining a modulation scheme and a channel coding rate according to the channel state of the electronic device may be applied. The 5G core network 360 may perform operations such as mobility support, bearer configuration, and QoS configuration. The 5G core network 360 is a device responsible for a mobility management function and various control functions for the NR electronic device 350 and may be connected to a plurality of base stations. In addition, the 5G network system may be linked with the LTE network. For example, the 5G core network 360 may be connected to an evolved packet core (EPC) 365 through a network interface. The MME 365 may be connected to the eNB 305.

FIG. 3D is a diagram illustrating a structure of a control plane protocol of a 5G network according to various embodiments.

Referring to FIG. 3D, the control plane radio protocol of the 5G network according to various embodiments may include an RRC 370, 375, a PDCP 371, 376, an RLC 372, 377, a MAC 373, 378, and a physical layer (PHY) 374, 379, respectively, in the electronic device 350 and the NR base station 355.

According to various embodiments, the RRCs 370 and 375 may perform at least one of, for example, system information transmission, RRC connection control, and channel measurement control.

According to various embodiments, the PDCPs 371 and 376 may perform at least one of, for example, compression/reconstruction of the IP header, data transmission, sequential delivery of protocol data unit (PDU) to the upper layer, data encryption and decryption, or timer-based SDU deduplication.

According to various embodiments, the PDCPs 371 and 376 may perform reordering PDCP PDUs received from a lower layer in order, based on a PDCP sequence number (SN) as a reordering function. For example, the PDCPs 371 and 376 may perform transferring data to an upper layer in a rearranged order. In addition, the PDCPs 371 and 376 may perform reordering the order to record the lost PDCP PDUs. The PDCPs 371 and 376 may perform reporting the status of the lost PDCP PDUs to the transmitting side, and may perform requesting retransmission of the lost PDCP PDUs.

According to various embodiments, the RLCs 372 and 377 may perform at least one of, for example, data transmission, protocol data unit (PDU) sequential delivery and out-of-order delivery function to upper layer, perform ARQ operation by re-configuring PDCP packet data unit (PDU) to an appropriate size, RLC SDU concatenation, division and reassembly, an RLC SDU deletion, and RLC re-establishment.

According to various embodiments, the RLCs 372 and 377 may perform sequentially delivering RLC SDUs received from a lower layer to an upper layer as an in-sequence delivery function. For example, when one RLC SDU is divided into several RLC SDUs and received, the RLCs 372 and 377 may perform reassembling and transferring the divided plurality of RLC SDUs. The RLCs 372 and 377 may perform rearranging the received RLC PDUs, based on an RLC sequence number (SN) or a PDCP sequence number (SN), and perform rearranging the order to record the lost RLC PDUs. The RLCs 372 and 377 may perform reporting the status of the lost RLC PDUs to the transmitting side, and may perform requesting retransmission of the lost RLC PDUs. When there is a lost RLC SDU, the RLCs 372 and 377 may perform sequentially transferring only RLC SDUs up to before the lost RLC SDU to a higher layer, or may perform sequentially transferring all RLC SDUs received before the timer starts to an upper layer if a predetermined timer expires even if there is a lost RLC SDU. The RLCs 372 and 377 may perform sequentially transferring all RLC SDUs received so far to an upper layer if a predetermined timer has expired even if there is a lost RLC SDU. In addition, by the sequential delivery function, the RLCs 372 and 377 may process the RLC PDUs in the order of reception (regardless of the order of serial numbers and sequence numbers, in the order of arrival) and deliver them to the PDCP regardless of the order (out-of-sequence delivery). Alternatively, the RLCs 372 and 377 may reconstruct the segments stored in the buffer or received into one complete RLC PDU, process them, and transfer them to the PDCPs 371 and 375. The RLCs 372 and 377 may not include a concatenation function and may be replaced by performing the concatenation function in the MACs 373 and 378 or multiplexing in the MACs 373 and 378.

According to various embodiments, the RLCs 372 and 377 in the above may perform delivering RLC SDUs received from the lower layer to the upper layer regardless of the order as an out-of-sequence delivery function. When one RLC SDU is divided into multiple RLC SDUs and received, the RLCs 372 and 377 may perform reassembling and delivering the divided and received RLC SDUs, and may perform storing the RLC SN or PDCP SN of the received RLC PDUs, sorting the order, and recording the lost RLC PDUs.

According to various embodiments, the MACs 373 and 378 may be connected to multiple RLCs 372 and 377 configured in one electronic device. The MACs 373 and 378 may perform at least one of, for example, multiplexing RLC PDUs to MAC PDUs and demultiplexing RLC PDUs from MAC PDUs, mapping between logical and transport channels, reporting of scheduling information, hybrid automatic repeat and request (HARQ), priority adjustment between logical channels, priority level adjustment between electronic devices, multimedia broadcast multicast services (MBMS) identification, transmission format selection, and a padding.

According to various embodiments, the physical layers (hereinafter referred to as “PHY”) 374 and 379 may channel-code and modulate upper layer data, make OFDM symbols, and transmit them through a wireless channel. In addition, the PHYs 374 and 379 may perform demodulating the OFDM symbol received through a radio channel, decoding the channel, and transmitting it to an upper layer.

FIG. 3E is a diagram illustrating a user plane protocol structure of a 5G network according to various embodiments.

Referring to FIG. 3E, the user plane radio protocol of a 5G network according to various embodiments may include a service data association protocol (SDAP) 380, 385, a PDCP 381, 386, an RLC 382, 387, a MAC 383, 388, and a physical layer (PHY) 384, 389 in the electronic device 350 and the NR base station 355, respectively.

According to various embodiments, the SDAPs 380 and 385 may perform routing or mapping quality of service flow (QoS flow) to a data radio bearer (DRB), for example. In addition, the SDAPs 380 and 385 may perform marking a QoS flow identifier on downlink packets. The SDAPs 380 and 385 may perform marking a QoS flow identifier on uplink packets.

According to various embodiments, the PDCPs 381 and 386 may perform at least one of compression/restore of IP header, data transmission, sequential delivery of protocol data unit (PDU) to upper layer, data encryption and decryption, or timer-based SDU deduplication.

According to various embodiments, the RLCs 382 and 387 may perform at least one of data transmission, protocol data unit (PDU) sequential delivery and out-of-order delivery function to upper layer, reconstructing the PDCP packet data unit (PDU) to an appropriate size to perform ARQ, RLC SDU concatenation, division and reassembly, RLC SDU deletion, and RLC re-establishment.

According to various embodiments, the MACs 383 and 388 may be connected to multiple RLCs 382 and 387 configured in one electronic device. For example, the MACs 383 and 388 may perform at least one of multiplexing the RLC PDUs to the MAC PDU and demultiplexing the RLC PDUs from the MAC PDU, mapping between a logical channel and a transport channel, scheduling information reporting, hybrid automatic repeat and request (HARQ), priority control between logical channels, priority level control between electronic devices, multimedia broadcast multicast services (MBMS) service identification, transmission format selection, and padding.

According to various embodiments, the physical layer (hereinafter referred to as “PHY”) 384 and 389 may channel-code and modulate higher layer data, make OFDM symbols, and transmit them through a wireless channel. In addition, the PHYs 384 and 389 may perform demodulating the OFDM symbol received through a radio channel, decoding the channel, and transmitting the demodulation to an upper layer.

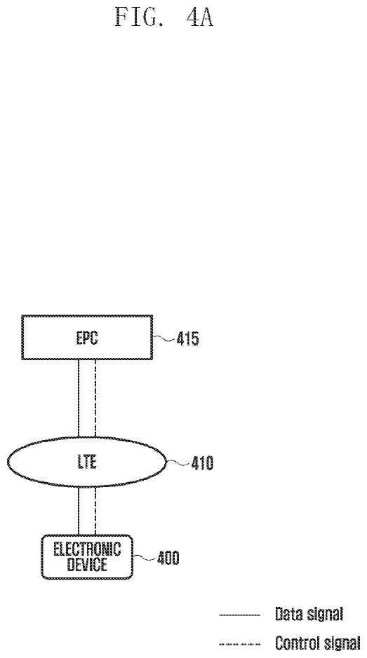

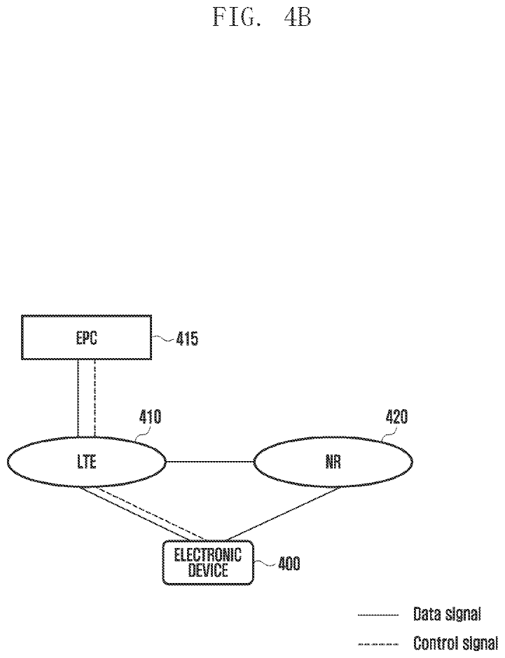

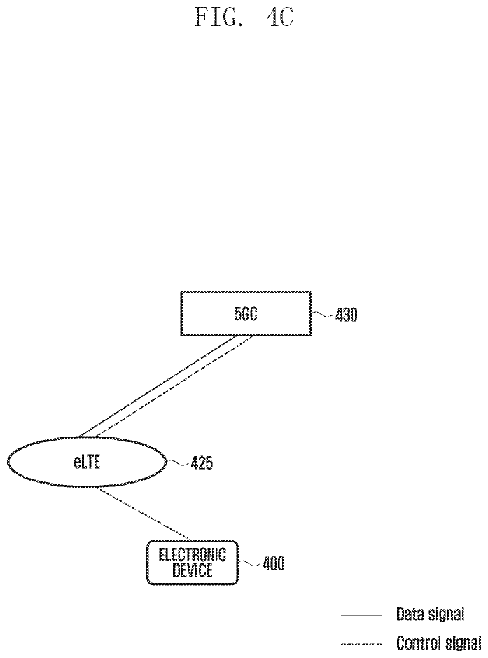

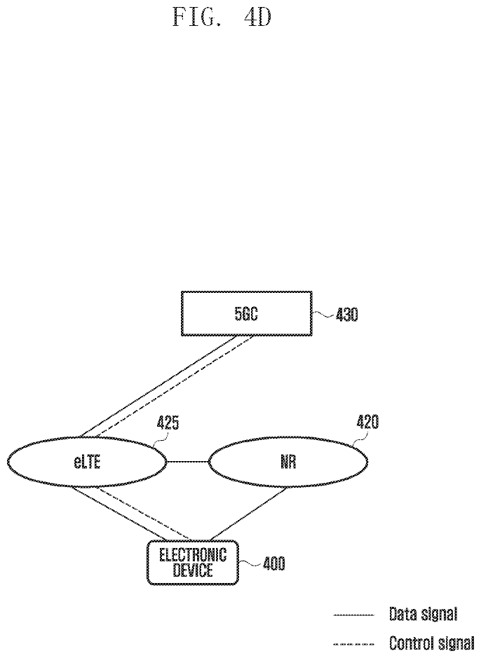

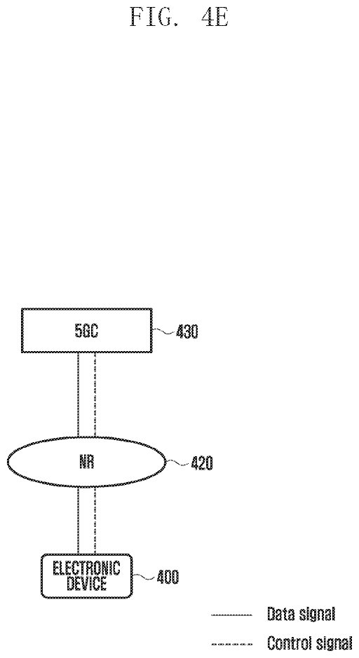

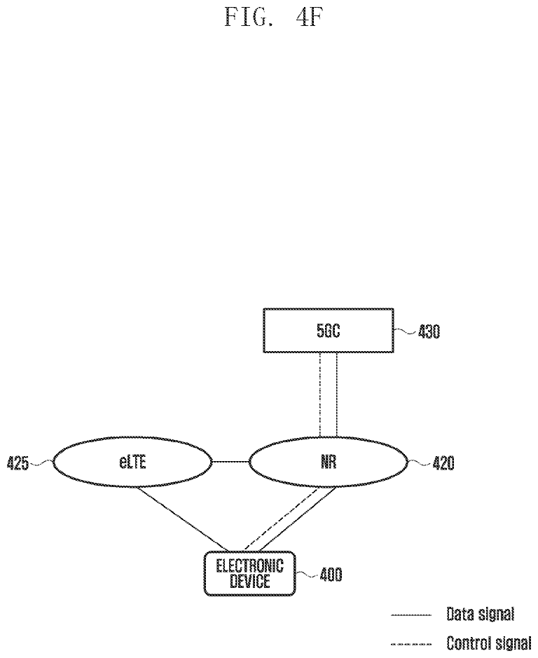

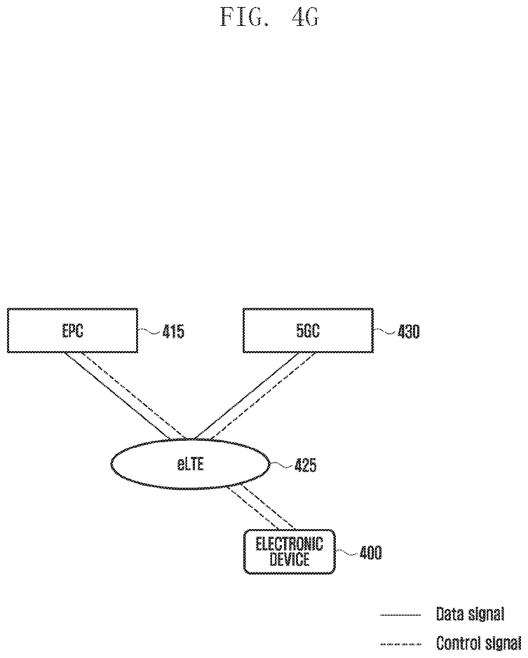

FIGS. 4A to 4G are diagrams illustrating a network structure in which at least some of a 4G network and a 5G network are mixed according to various embodiments.

Referring to FIG. 4A, when a network according to various embodiments is disposed (hereinafter, option 1), an electronic device 400 (e.g., 101 of FIG. 1) may be camp on an LTE cell (or eNB) 410. The electronic device 400 may access the EPC 415 by performing a NAS procedure.

According to various embodiments, the NAS procedure may include, for example, an attach procedure for an electronic device to perform a procedure such as registration in a core network, a service request procedure for switching an idle state of an electronic device to a connected state, a tracking area update (TAU) procedure for updating a tracking area according to movement of the electronic device, and the like. The electronic device 400 may independently transmit and receive a control signal and a data signal through the LTE cell 410 and the EPC 415.

An NSA structure (hereinafter, option 3) according to various embodiments will be described with reference to FIG. 4B. Option 3 according to an embodiment may be a network structure supporting dual connectivity to the LTE cell 410 and the NR cell (or NR gNB) 420. The electronic device 400 (e.g., 101 of FIG. 1) may camp on the LTE cell 410 and perform a 4G NAS procedure. The electronic device 100 may transmit and receive a control signal and a data signal through the LTE cell 410 and the EPC 415. The electronic device 400 may transmit and receive user data through the LTE cell 410 and the NR cell 420 connected through a network interface.

Referring to FIGS. 4C and 4D, in a network (hereinafter, option 5 and option 7, respectively) according to various embodiments, the enhanced LTE (eLTE) cell 425 may prevent camping of the electronic device 400 (e.g., 101 of FIG. 1) attempting to perform a 5G NAS procedure with an EPC.

According to various embodiments, in option 5 and option 7, the eLTE cell 425 may be configured to receive a 5th generation core network (5GC) 430 and a control signal and a data signal. The electronic device 400 (e.g., 101 of FIG. 1) may camp on the eLTE cell 425 and perform a 5G NAS procedure to register it in the 5G core network 5GC 430. The electronic device 400 may transmit and receive a control signal and a data signal through the eLTE cell 425 and the 5GC 430.

Referring to FIG. 4D, option 7 according to an embodiment may be a network structure supporting dual connectivity to an eLTE cell 425 and an NR cell 420. The electronic device 400 (e.g., 101 of FIG. 1) may transmit and receive data signals through two cells (eLTE cell 425 and NR cell 420). For example, the electronic device 100 may transmit and receive a control signal and a data signal through the eLTE cell 425 and the 5GC 430. The electronic device 400 may transmit and receive user data through the eLTE cell 425 and the NR cell 420 connected through a network interface.

Referring to FIGS. 4E and 4F, when a network according to various embodiments (hereinafter, option 2 and option 4, respectively) is arranged, the electronic device 400 (e.g., 101 of FIG. 1) may camp on the NR cell 420. The electronic device 400 may perform a 5G NAS procedure and register it with the 5GC 430, which is a 5G core network.

Referring to FIGS. 4E and 4F, in option 2 and option 4 according to various embodiments, the NR cell 420 may be configured to transmit and receive the 5GC 430 and at least one of a control signal or a data signal. The electronic device 400 (e.g., 101 of FIG. 1) may camp on the NR cell 420 and perform a 5G NAS procedure to access the 5G core network 5GC 430. The electronic device 400 may independently transmit and receive a control signal and a data signal through the NR cell 420 and the 5GC 430.

Referring to FIG. 4F, option 4 according to an embodiment may be a network structure supporting dual connectivity to an eLTE cell 425 and an NR cell 420. The electronic device 400 (e.g., 101 of FIG. 1) may transmit and receive data through two cells (eLTE cell 425 and NR cell 420). The electronic device 100 may transmit and receive a control signal and a data signal through the NR cell 420 and the 5GC 430. The electronic device 400 may transmit and receive user data through the NR cell 420 and the eLTE cell 425 connected through a network interface.

Referring to FIG. 4G, in a dual-core eLTE network according to various embodiments, when an electronic device 400 (e.g., 101 of FIG. 1) supports 4G wireless communication and 5G wireless communication, the electronic device 400 may camp on the eLTE cell 425. In addition, the electronic device 400 (e.g., 101 of FIG. 1) may register in at least one of the EPC 415 or 5GC 430 by performing a 4G NAS or 5G NAS procedure. The electronic device 100 may transmit and receive a control signal and a data signal through the eLTE cell 425 and the EPC 415. Alternatively, the electronic device 100 may transmit and receive a control signal and a data signal through the eLTE cell 425 and 5GC 430.

Referring to FIG. 4G, an eLTE cell 425 according to various embodiments may transmit information indicating a type of supported core network. For example, the eLTE cell 425 may transmit information indicating that both the 5GC 430 and the EPC 415 are supported. For example, the eLTE cell 425 may transmit information indicating that both the 5GC 430 and the EPC 415 are supported by configuring the “cellBarred flag” value other than “cellBarred” or not having the “cellBarred flag” value in the transmitted SIB1.

Referring to FIG. 4G, an electronic device 400 (e.g., 101 of FIG. 1) that has received information indicating that both the 5GC 430 and the EPC 415 are supported from the eLTE cell 425 according to various embodiments may perform a 4G NAS or 5G NAS procedure, based on the network selection information. For example, based on the state of the electronic device 400 (e.g., 101 of FIG. 1), the electronic device 400 (e.g., 101 of FIG. 1) may register with at least one of the EPC 415 and the 5GC 430.

Referring to FIG. 4G, according to an embodiment, the electronic device 400 (e.g., 101 of FIG. 1) may determine a core network to be registered, based on an application executed in the electronic device 400 (e.g., 101 of FIG. 1). For example, when an application requesting a 5G wireless communication service such as eMBB or URLLC is running on the electronic device 400 (e.g., 101 of FIG. 1), the electronic device 400 (e.g., 101 of FIG. 1) may determine to perform the 5G NAS procedure.

Referring to FIG. 4G, according to another embodiment, when an application requesting a 5G wireless communication service is not running, the electronic device 400 (e.g., 101 of FIG. 1) may determine to perform a 4G NAS procedure.

Referring to FIG. 4G, according to various embodiments, the eLTE cell 425 may inform information that only 5GC 430 is supported. For example, the eLTE cell 425 may transmit information indicating that only 5GC 430 is supported, for example, by configuring the ‘cellBarred flag’ value as ‘cellBarred’ using the ‘cellBarred flag’ value in the transmitted SIB1.

Referring to FIG. 4G, according to various embodiments, an electronic device 400 (e.g., 101 of FIG. 1) that has received information indicating that only 5GC 430 is supported from an eLTE cell 425 may know that the eLTE cell 425 supports only the 5GC 430, based on the ‘cellBarred flag’ value of SIB 1 transmitted from the eLTE cell 425. Accordingly, the electronic device 400 (e.g., 101 of FIG. 1) may perform a 5G NAS procedure.

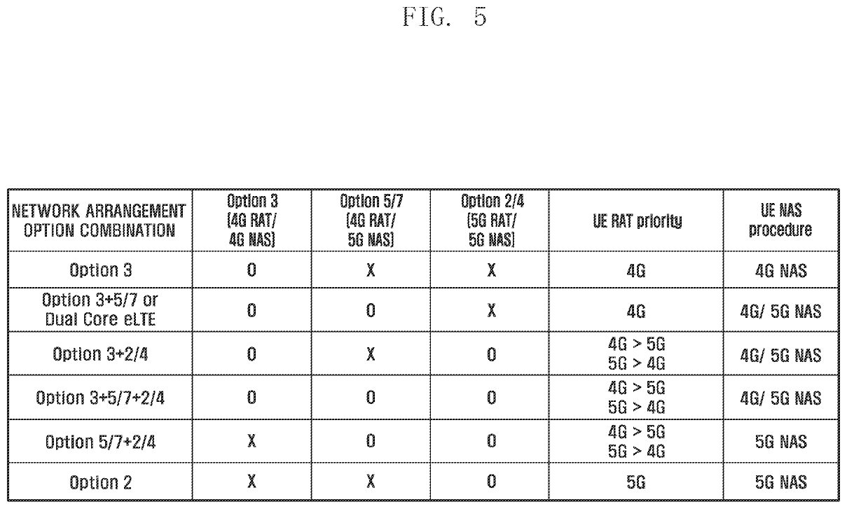

FIG. 5 is a table showing wireless communication priorities and a non-access stratum (NAS) procedure available in an electronic device (e.g., 101 of FIG. 1) according to a combination of communication network arrangement options according to various embodiments.

Referring to FIG. 5, according to a combination of network configuration options according to various embodiments, the wireless communication priority available in the electronic device (e.g., 101 of FIG. 1) may be 4G RAT or 5G RAT. The wireless communication priority may be temporarily stored in at least one of, for example, a memory (e.g., memory 130 of FIG. 1) or a subscriber identification module (e.g., subscriber identification module 196 of FIG. 1) of the electronic device (e.g., 101 of FIG. 1). The wireless communication priority may be defined and stored in, for example, an electronic device (e.g., 101 of FIG. 1). For another example, the wireless communication priority may be determined based on a combination of supported network configuration options, a preference of an electronic device (e.g., 101 of FIG. 1), or information received from a network. The electronic device (e.g., 101 of FIG. 1) may select a cell to camp on, based on a wireless communication priority. In addition, the NAS procedure may be performed by at least one of a 4G NAS procedure or a 5G NAS procedure.

According to various embodiments, as disclosed in FIG. 5, when only a network corresponding to option 3 is arranged, the wireless communication priority of the electronic device (e.g., 101 of FIG. 1) may be 4G RAT. The electronic device (e.g., 101 of FIG. 1) may camp on the LTE cell (e.g., the LTE cell 410 of FIG. 4B), based on the wireless communication priority, and may be determined to perform a 4G NAS procedure.

According to various embodiments, when networks corresponding to option 3 and option 5 or option 7 are mixed and disposed, or when a dual core eLTE network is disposed, since there are both option 3 to support 4G RAT and 4G NAS and option 5 or option 7 to support 5G RAT and 5G NAS, the wireless communication priority of the electronic device (e.g., 101 of FIG. 1) may be 4G RAT. The electronic device (e.g., 101 of FIG. 1) may camp on an LTE cell (e.g., LTE cell 410 of FIG. 4B) or an eLTE cell (e.g., eLTE cell 425 of FIG. 4C), which are 4G RATs, according to the network option, and may be determined to perform the 4G NAS or 5G NAS procedure.

According to various embodiments, when networks corresponding to option 3 and option 2 or option 4 are mixed and disposed, since there are both Option 3 to support 4G RAT and 4G NAS and Option 2 or Option 4 to support 5G RAT and 5G NAS, the electronic device (e.g., 101 of FIG. 1) may camp on with a 4G RAT or a 5G RAT, based on the wireless communication priority of the electronic device (e.g., 101 of FIG. 1). For example, when the wireless communication priority of the electronic device 101 is 4G RAT, the electronic device (e.g., 101 of FIG. 1) may camp on an LTE cell (e.g., LTE cell 410 of FIG. 4B) or an eLTE cell (e.g., eLTE cell 425 of FIG. 4C), which are 4G RATs. For another example, when the wireless communication priority is 5G RAT, the electronic device (e.g., 101 of FIG. 1) may camp on an NR cell (e.g., NR cell 420 of FIG. 4E) that is a 5G RAT. In addition, the electronic device (e.g., 101 of FIG. 1) may be determined to perform a 4G NAS or 5G NAS procedure, based on the core network preference of the electronic device (e.g., 101 of FIG. 1).

According to various embodiments, when networks corresponding to option 3, option 5 or option 7, and option 2 or option 4 are mixed and disposed, since there are option 3 to support 4G RAT and 4G NAS, option 5 or option 7 to support 4G RAT and 5G NAS, and option 2 or option 4 to support 5G RAT and 5G NAS, the electronic device (e.g., 101 of FIG. 1) may camp on with a 4G RAT or a 5G RAT, based on the wireless communication priority of the electronic device (e.g., 101 of FIG. 1). For example, when the wireless communication priority of the electronic device (e.g., 101 of FIG. 1) is 4G RAT, the electronic device (e.g., 101 of FIG. 1) may camp on an LTE cell (e.g., LTE cell 410 of FIG. 4B) or an eLTE cell (e.g., eLTE cell 425 of FIG. 4C), which are 4G RATs. For another example, when the wireless communication priority is 5G RAT, the electronic device (e.g., 101 of FIG. 1) may camp on an NR cell (e.g., NR cell 420 of FIG. 4E) that is a 5G RAT. In addition, the electronic device may be determined to perform a 4G NAS or 5G NAS procedure, based on the core network preference of the electronic device (e.g., 101 of FIG. 1).

According to various embodiments, when networks corresponding to option 5 or option 7 and option 2 or option 4 are mixed and disposed, since there is option 5 or option 7 to support 4G RAT and 5G NAS and option 2 or option 4 to support 5G RAT and 5G NAS, the electronic device (e.g., 101 of FIG. 1) may camp on with a 4G RAT or a 5G RAT, based on the wireless communication priority of the electronic device (e.g., 101 of FIG. 1). For example, when the wireless communication priority of the electronic device (e.g., 101 of FIG. 1) is 4G RAT, the electronic device (e.g., 101 of FIG. 1) may camp on an LTE cell (e.g., LTE cell 410 of FIG. 4B) or an eLTE cell (e.g., eLTE cell 425 of FIG. 4C) which are 4G RATs. For another example, when the wireless communication priority is 5G RAT, the electronic device (e.g., 101 of FIG. 1) may camp on an NR cell (e.g., NR cell 420 of FIG. 4E) that is a 5G RAT. In addition, the electronic device (e.g., 101 of FIG. 1) may be determined to perform a 5G NAS procedure.

According to various embodiments, when only a network corresponding to option 2 is disposed, the wireless communication priority of the electronic device (e.g., 101 of FIG. 1) may be 5G RAT. The electronic device (e.g., 101 of FIG. 1) may camp on an NR cell (e.g., NR cell 420 of FIG. 4E) that is a 5G RAT, based on the wireless communication priority, and may be determined to perform a 5G NAS procedure.

According to various embodiments, the electronic device (e.g., 101 of FIG. 1) may determine a wireless communication priority of the electronic device, based on at least one of a combination of supported network configuration options, a preference of the electronic device, or information received from a network. For another example, a value determined for the wireless communication priority may be stored in the electronic device.

According to various embodiments, the electronic device (e.g., 101 of FIG. 1) may store information on which cell is a more preferred cell among 4G RAT or 5G RAT. The electronic device 101 may determine a wireless communication priority, based on at least a part of the preference. For example, the electronic device (e.g., 101 of FIG. 1) may store preference information indicating that NSA network deployment is preferred over SA. For example, in an area where the NSA (option 3) and the SA (option 2) overlap, the electronic device (e.g., 101 of FIG. 1) may store a preference for connecting to the NSA network. The electronic device (e.g., 101 of FIG. 1) may determine the wireless communication priority as 4G RAT, based on the preference.

According to various embodiments, the electronic device (e.g., 101 of FIG. 1) may store information (e.g., a policy that can be used in an electronic device) received from a network when searching for a cell or registering with a base station. The electronic device (e.g., 101 of FIG. 1) may receive a policy provided by the registered network when registering the network. The policy may include, for example, information (e.g., 4G RAT or 5G RAT) instructing the network to use a specific RAT by the electronic device (e.g., 101 of FIG. 1). The electronic device (e.g., 101 of FIG. 1) may change the RAT based at least in part on the received policy or use it when searching for the next cell.

According to various embodiments, the policy may include information (e.g., information that option 3 has a higher priority than option 2) instructing the electronic device (e.g., 101 of FIG. 1) to select a specific option with priority. If network arrangements of option 3 and option 2 are mixed, based on at least part of the received policy, the electronic device (e.g., 101 of FIG. 1) may determine that option 3 is preferred over option 2. Accordingly, the electronic device (e.g., 101 of FIG. 1) may determine the wireless communication priority as 4G RAT.

According to various embodiments, the electronic device may search for a network (or cell), based at least in part on the wireless communication priority of the electronic device (e.g., 101 of FIG. 1). For example, in order to search for a cell to be camped on, the electronic device (e.g., 101 of FIG. 1) may first search for frequency bands corresponding to the LTE band when the radio communication priority is a 4G RAT, and may first search for frequency bands corresponding to the NR band when the radio communication priority is a 5G RAT.

According to various embodiments, the electronic device (e.g., 101 of FIG. 1) may attempt to register to a network (e.g., to a core network), based on at least one piece of network information (e.g., a master information block (MIB), a system information block (SIB)) received during cell search and core network preference of the electronic device (e.g., 101 of FIG. 1).

According to various embodiments, the electronic device (e.g., 101 of FIG. 1) may identify a core network supported by the searched network and perform a non-access stratum (NAS) procedure based on the identified core network. For example, in a network structure (e.g., option 1, option 3) supporting only EPC, the electronic device (e.g., 101 of FIG. 1) may perform a 4G NAS procedure with an EPC. As another example, in a network structure (e.g., option 5, option 7, option 2, option 4) supporting only 5GC, the electronic device (e.g., 101 of FIG. 1) may perform a 5G NAS procedure with 5GC.

According to various embodiments, the electronic device (e.g., 101 of FIG. 1) may receive information indicating the type of core network supported by a corresponding cell from a 4G base station or a 5G base station. For example, in the network structure of option 5, when searching for an eLTE cell (e.g., eLTE 425 of FIG. 4c), the electronic device (e.g., 101 of FIG. 1) may receive information indicating that the cell supports 5GC from the base station. Alternatively, in the dual-core eLTE (e.g., eLTE 425 of FIG. 4G) network structure, the electronic device (e.g., 101 of FIG. 1) may receive information indicating that the cell supports EPC and NCG from the eLTE base station. For example, information indicating the type of supported core network may be included in at least one of MIBs and SIBs.

According to various embodiments, the electronic device (e.g., 101 of FIG. 1) may attempt to register with the EPC or 5GC, based on the preference of the core network. For example, the electronic device (e.g., 101 of FIG. 1) may perform a 4G NAS procedure with EPC or a 5G NAS procedure with 5GC, based on the core network preference of the electronic device (e.g., 101 of FIG. 1)

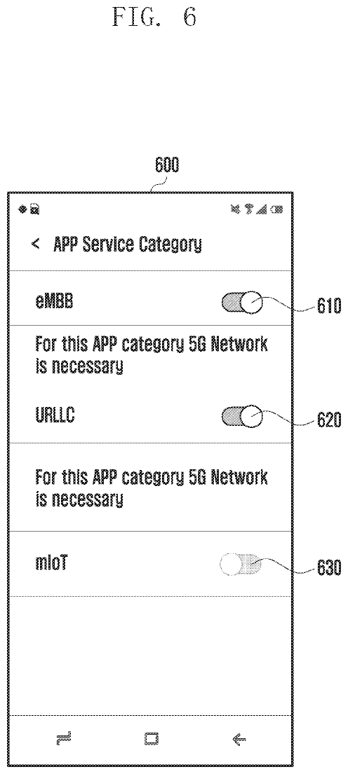

FIG. 6 is a diagram illustrating a UI 600 for controlling activation of an application requesting a 5G service in an electronic device (e.g., 101 of FIG. 1) according to various embodiments.

According to various embodiments, a core network preference of an electronic device (e.g., 101 of FIG. 1) may be determined based on the type of application installed in the electronic device (e.g., 101 of FIG. 1) or running on the electronic device (e.g., 101 of FIG. 1). For example, in the electronic device (e.g., 101 of FIG. 1), there may be applications that require 5G services such as enhanced mobile broadband (eMBB) and ultra-reliable and low latency communications (URLLC).

According to an embodiment, as illustrated in FIG. 6, a 5G service may be activated by a user through a user interface (UI) 600 or the like. FIG. 6 illustrates a state in which a UI 610 for eMBB and a UI 620 for URLLC are activated by a user, and a UI 630 for mIoT is not activated, according to an embodiment. When at least one 5G service (e.g., eMBB and URLLC of FIG. 6) is activated through the UI 600, the electronic device (e.g., 101 of FIG. 1) may determine the core network preference as 5GC.

According to an embodiment, when all 5G services are deactivated or all 5G service-related applications are deactivated through the UI 600, the electronic device (e.g., 101 of FIG. 1) may determine the core network preference as EPC. For example, when the UI 610 for eMBB, the UI 620 for URLLC, and the UI 630 for mIoT are deactivated, the electronic device (e.g., 101 of FIG. 1) may determine the core network preference as EPC.

According to an embodiment, the electronic device (e.g., 101 of FIG. 1) may generate a PDU session necessary for the application service category service.

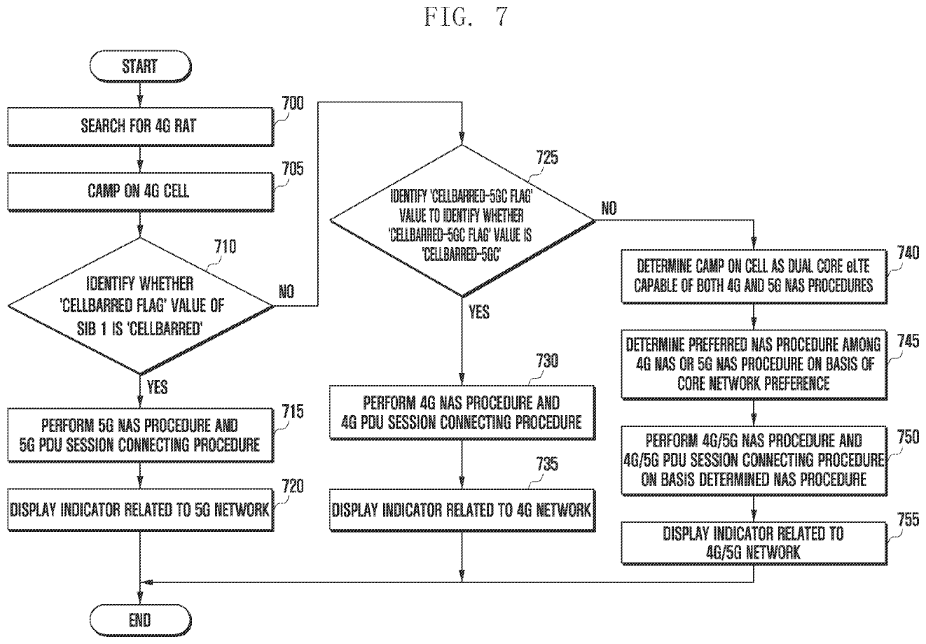

FIG. 7 is a flowchart illustrating a method of connecting an electronic device (e.g., 101 of FIG. 1) to a 4G network or a 5G network according to various embodiments.

Hereinafter, referring to FIG. 7, according to various embodiments, an operation of an electronic device (e.g., 101 of FIG. 1) searching for a 4G RAT, camping on a 4G cell, and performing a 4G NAS or 5G NAS procedure will be described.

According to various embodiments, operations 700 to 755 may be executed through any one of an electronic device (e.g., 101 of FIG. 1), a processor (e.g., 120 of FIG. 1), a main processor (or application processor) (e.g., 121 of FIG. 1), a secondary processor (e.g., a communication processor) (e.g., 123 of FIG. 1), or a wireless communication module (e.g., 192 of FIG. 1). According to various embodiments, as network arrangement options for 4G cells, option 1, option 3, option 5 or 7 and dual core eLTE networks may exist.

According to various embodiments, in operation 700, an electronic device (e.g., 101 of FIG. 1) supporting 4G and 5G wireless communication may search for a 4G RAT.

According to various embodiments, when the wireless communication priority of the electronic device (e.g., 101 of FIG. 1) is determined to be 4G RAT, the electronic device (e.g., 101 of FIG. 1) may first search for a frequency band corresponding to the LTE band. According to various embodiments, the electronic device may receive information broadcast in a 4G cell. Information broadcast by the cell may include, for example, a master information block and a system information block (SIB).

According to various embodiments, in operation 705, the electronic device (e.g., 101 of FIG. 1) may camp on (or select) the 4G cell.

According to various embodiments, in operation 710, the electronic device (e.g., 101 of FIG. 1) may identify a ‘cellBarred flag’ value of SIB1 received from a network. When the ‘cellBarred flag’ value is ‘cellBarred’, the electronic device may determine the detected 4G cell as a cell capable of supporting only 5G NAS corresponding to option 5 or option 7. According to various embodiments, in operation 715, the electronic device (e.g., 101 of FIG. 1) may perform a 5G NAS procedure and a 5G PDU session connection procedure. In addition, when the procedure is successful, the electronic device (e.g., 101 of FIG. 1) may transmit information indicating that the user can use 5G service to the application processor (e.g., the main processor 121 of FIG. 1).

According to various embodiments, in operation 720, the electronic device (or application processor) (e.g., the main processor 121 of FIG. 1) may display an indicator related to the 5G network using a display (e.g., the display device 160 of FIG. 1).

According to various embodiments, as a result of the determination in operation 710, when the ‘cellBarred flag’ value is not ‘cellBarred’, in operation 725, the electronic device (e.g., 101 of FIG. 1) may determine the ‘cellBarred-5GC flag’ value. As a result of the determination, when the value of the ‘cellBarred-5GC flag’ is ‘cellBarred-5GC’, the electronic device (e.g., 101 of FIG. 1) may determine the cell corresponding to option 1 or option 3. Accordingly, in operation 730, the electronic device may perform a 4G NAS procedure and a 4G PDN session connection procedure. In addition, when the procedure is successful, the electronic device (e.g., 101 of FIG. 1) may transmit information that the user can use the 4G service to the application processor (e.g., the main processor 121 of FIG. 1). According to various embodiments, in operation 735, the electronic device (e.g., 101 of FIG. 1) (or application processor) (e.g., the main processor 121 of FIG. 1) may display an indicator related to a 4G network using a display (e.g., the display device 160 of FIG. 1). In the case of option 3, the NR cell may be in the form of dual connectivity. Therefore, depending on whether or not the NR cell is operating, the electronic device (e.g., 101 of FIG. 1) may notify the application processor (e.g., the main processor 121 of FIG. 1) that 5G service is available instead of 4G, and display an indicator related to a 5G network using a display (e.g., the display device 160 of FIG. 1).

According to various embodiments, as a result of determination in operation 725, when the value of the ‘cellBarred-5GC flag’ is not ‘cellBarred-5GC’, in operation 740, the electronic device (e.g., 101 of FIG. 1) may determine the detected cell as a dual-core eLTE cell capable of both 4G or 5G NAS procedures.

According to various embodiments, in operation 745, based on the core network preference of the electronic device (e.g., 101 of FIG. 1), the electronic device (e.g., 101 of FIG. 1) may determine to perform a preferred NAS procedure among 4G NAS or 5G NAS procedures.

According to various embodiments, in operation 750, the electronic device (e.g., 101 of FIG. 1) may perform a 4G or 5G NAS procedure and a 4G or 5G PDN session connection procedure according to the determined NAS procedure. In addition, when the procedure is successful, the electronic device (e.g., 101 of FIG. 1) may transmit information on a wireless communication system that can be used by a user to an application processor (e.g., the main processor 121 of FIG. 1). According to various embodiments, in operation 755, an electronic device (e.g., 101 of FIG. 1) (or application processor) (e.g., the main processor 121 of FIG. 1) may display an indicator related to a 4G or 5G network using a display (e.g., the display device 160 of FIG. 1).

According to various embodiments, as a network arrangement options for a 4G cell, option 1, option 3, option 5, option 7, or dual core eLTE may be used. Accordingly, as shown in Table 1 below, the 4G cell can be classified into an LTE cell and an eLTE cell. In addition, depending on the supported core network, it may be classified as 1) option 1 or option 3 that supports only EPC for LTE cells, 2) option 5 or option 7 that supports only 5GC for eLTE cells, or 3) dual-core eLTE that supports both of EPC and 5GC.

TABLE 1

| Cell | LTE cell | eLTE cell |
|---|---|---|
| Core network | 1) EPC only | 2) 5GC only |
| | (options 1, 3) | (cellBarred in |
| | | SIB 1-option 5/7) |
| | | 3) Both EPC/5GC |
| | | (dual core eLTE) |

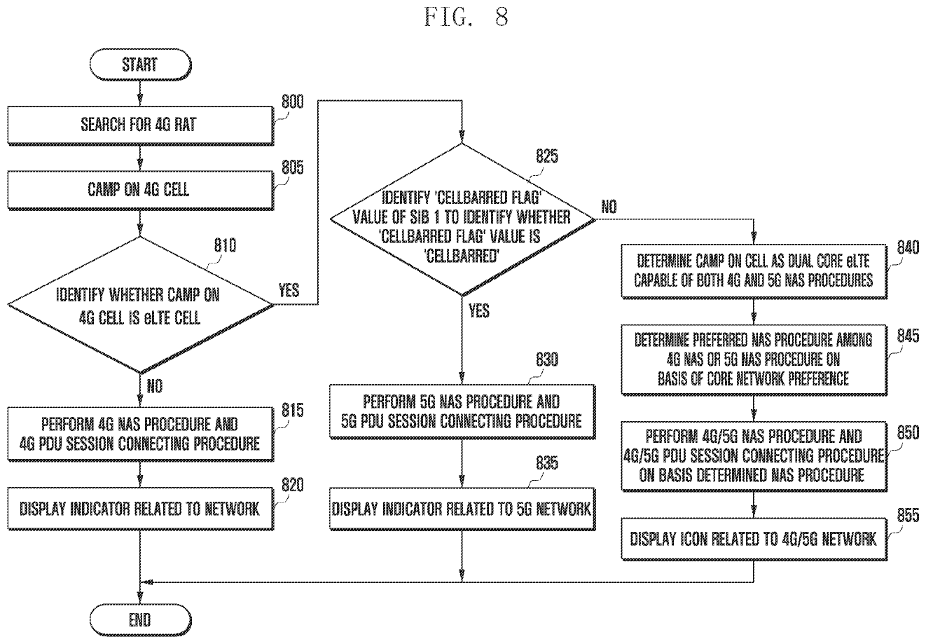

FIG. 8 is a flowchart illustrating a method of connecting an electronic device (e.g., 101 of FIG. 1) to a 4G network or a 5G network according to various embodiments. Referring to FIG. 8, according to various embodiments, a method for an electronic device (e.g., 101 of FIG. 1) supporting 4G and 5G wireless communication to access a network by determining whether a searched 4G cell is an LTE cell or an eLTE will be described. According to various embodiments, operations 800 to 855 may be executed through any one of an electronic device (e.g., 101 of FIG. 1), a processor (e.g., 120 of FIG. 1), a main processor (or application processor) (e.g., 121 of FIG. 1), a secondary processor (e.g., a communication processor) (e.g., 123 of FIG. 1), or a wireless communication module (e.g., 192 of FIG. 1).

According to various embodiments, in operation 800, the electronic device supporting 4G and 5G wireless communication (e.g., 101 of FIG. 1) may search for a 4G RAT.

According to various embodiments, when the wireless communication priority of the electronic device (e.g., 101 of FIG. 1) is determined as 4G RAT, the electronic device (e.g., 101 of FIG. 1) may first search for a frequency band corresponding to the LTE band.

According to various embodiments, an electronic device (e.g., 101 of FIG. 1) may receive information broadcast in a 4G cell. Information broadcast by the cell may include, for example, a master information block and a system information block (SIB).

According to various embodiments, in operation 805, the electronic device (e.g., 101 of FIG. 1) may camp on (or select) the 4G cell.

According to various embodiments, in operation 810, the electronic device (e.g., 101 of FIG. 1) may determine whether the camped 4G cell is an eLTE cell. For example, based on the system information received from the network, the electronic device (e.g., 101 of FIG. 1) may determine whether the camped 4G cell is an eLTE cell. As a result of the determination, if the camped 4G cell is not an eLTE cell, the electronic device (e.g., 101 of FIG. 1) may determine the 4G cell as a cell corresponding to option 1 (e.g., 410 of FIG. 4A) or a cell corresponding to option 3 (e.g., 410 of FIG. 4B).

According to various embodiments, in operation 815, the electronic device (e.g., 101 of FIG. 1) may perform a 4G NAS procedure and a 4G PDN session connection procedure. In addition, when the procedure is successful, the electronic device (e.g., 101 of FIG. 1) may transmit information indicating that the user can use the 4G service to the application processor (e.g., the main processor 121 of FIG. 1). According to various embodiments, in operation 820, an electronic device (e.g., 101 of FIG. 1) (or application processor) (e.g., the main processor 121 of FIG. 1) may display an indicator related to a 4G network using a display (e.g., the display device 160 of FIG. 1).

According to various embodiments, as a result of the determination, when the 4G cell on which the electronic device (e.g., 101 of FIG. 1) has camped on is an eLTE cell, in operation 825, the electronic device (e.g., 101 of FIG. 1) may identify a ‘cellBarred flag’ value of SIB 1 received from a network. When the ‘cellBarred flag’ value is ‘cellBarred’, the electronic device (e.g., 101 of FIG. 1) may determine the detected 4G cell as a cell capable of supporting only 5G NAS corresponding to option 5 or option 7. Accordingly, in operation 830, the electronic device (e.g., 101 of FIG. 1) may perform a 5G NAS procedure and a 5G PDU session connection procedure. In addition, when the procedure is successful, the electronic device (e.g., 101 of FIG. 1) may transmit information indicating that a user can use a 5G service to an application processor (e.g., the main processor 121 of FIG. 1). In operation 835, the electronic device (e.g., 101 of FIG. 1) (or application processor (e.g., the main processor 121 of FIG. 1)) may display an indicator related to the 5G network using a display (e.g., the display device 160 of FIG. 1).

According to various embodiments, when the ‘cellBarred flag’ value is not ‘cellBarred’ as a result of determination in operation 825, in operation 840, the electronic device (e.g., 101 of FIG. 1) may determine that the camped 4G cell is a dual core eLTE cell capable of performing both a 4G NAS procedure or a 5G NAS procedure.

According to various embodiments, in operation 845, based on the core network preference of the electronic device (e.g., 101 of FIG. 1), the electronic device (e.g., 101 of FIG. 1) may determine a preferred NAS procedure from among 4G NAS or 5G NAS procedures.

According to various embodiments, in operation 850, the electronic device (e.g., 101 of FIG. 1) may perform a 4G or 5G NAS procedure and a 4G or 5G PDN session connection procedure according to the determined NAS procedure. In addition, when the procedure is successful, the electronic device (e.g., 101 of FIG. 1) may transmit information about a wireless communication system that can be used by a user to an application processor (e.g., the main processor 121 of FIG. 1). Further, in operation 855, the electronic device (e.g., 101 of FIG. 1) (or application processor (e.g., the main processor 121 of FIG. 1)) may display an indicator related to a 4G or 5G network by using a display (e.g., the display device 160 of FIG. 1).

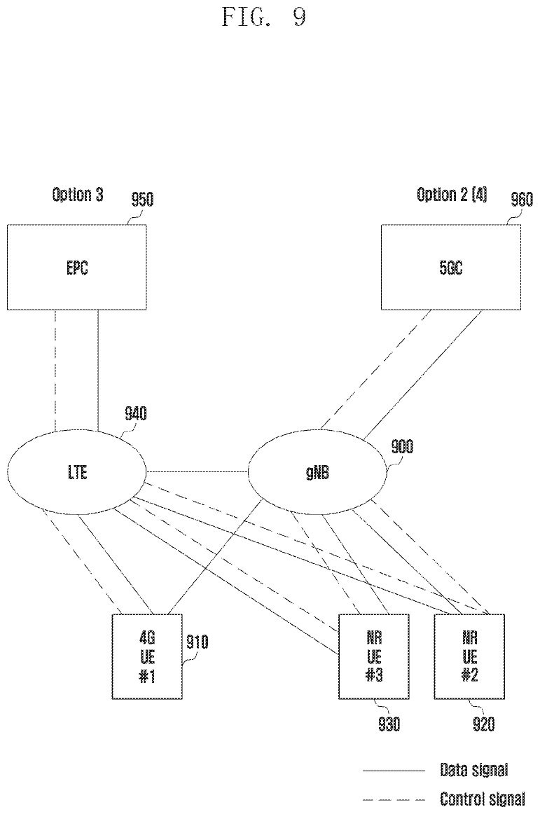

FIG. 9 is a diagram illustrating a network arrangement according to various embodiments.

According to various embodiments, an NR base station 900 may be an NR cell with dual connectivity in option 3 and an NR cell in option 2 or option 4. An electronic device (e.g., 101 of FIG. 1) may find an LTE cell 940 of option 3 when searching for 4G RAT, and the NR cell 900 of option 2 when searching for 5G RAT. Accordingly, the electronic devices 1 to 3 910 to 930 of FIG. 9 may camp on different cells and perform different NAS procedures, respectively, based on at least one of a combination of network deployment options supported by each electronic device, preference, or information received from the network.

According to various embodiments, in FIG. 9, it is assumed that the electronic device 1 910 is determined to support only 4G wireless communication, the electronic device 2 920 is determined to prefer option 2 (SA) while supporting 4G and 5G wireless communication, and the electronic device 3 930 is determined to prefer option 3 (NSA) to option 2 (SA) while supporting 4G and 5G wireless communication.

According to various embodiments, since the electronic device 1 910 is an electronic device that supports only 4G wireless communication, the wireless communication priority of the electronic device is 4G RAT, and may camp on the LTE cell 940 to perform a 4G NAS procedure. Accordingly, the electronic device 1 910 may register with the EPC 950.

According to various embodiments, since the electronic device 2 920 supports 4G and 5G wireless communication and prefers option 2 (SA), the wireless communication priority of the electronic device is configured as 5G RAT, and may search for a frequency band corresponding to the 5G RAT. Accordingly, the electronic device 2 920 may camp on the NR cell 900 and perform a 5G NAS procedure to access the 5GC 960.

According to various embodiments, the electronic device 3 930 may store information received from a network (e.g., a policy that can be used in the electronic device) when searching for a cell or registering with a base station. The electronic device 3 930 may change the wireless communication priority when selecting the next public land mobile network (PLMN) or selecting the RAT, according to the information received from the network (e.g., a policy that can be used in the electronic device).

According to various embodiments, the electronic device 3 930 may receive information (e.g., 4G RAT or 5G RAT) instructing the electronic device 3 930 to use a specific RAT from the network as a policy. For example, if the electronic device 3 930 receives information that the wireless communication priority is 5G RAT as a policy, the electronic device 3 930 may first search for a frequency band corresponding to the 5G RAT in the next PLMN selection or RAT selection. Further, the electronic device 3 930 may camp on the NR cell 900 corresponding to the 5G RAT and perform a 5G NAS procedure.

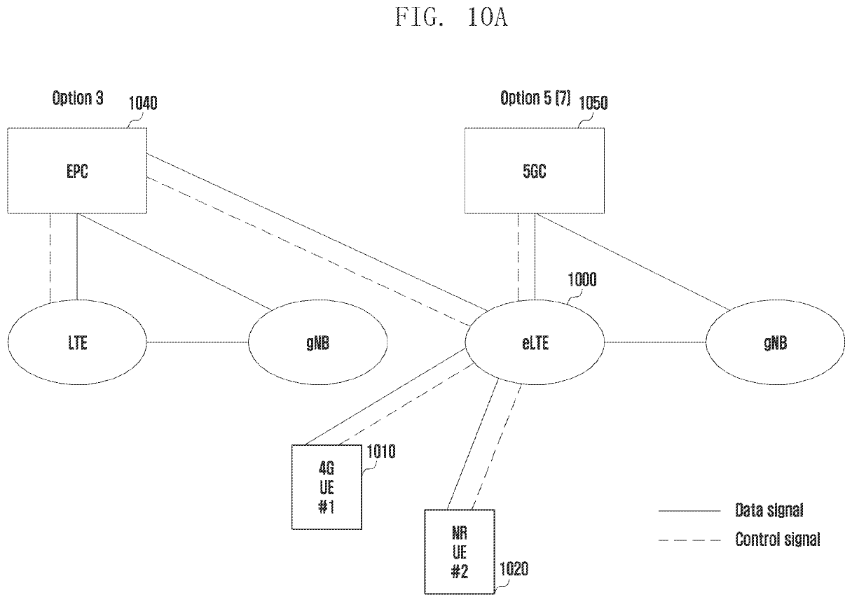

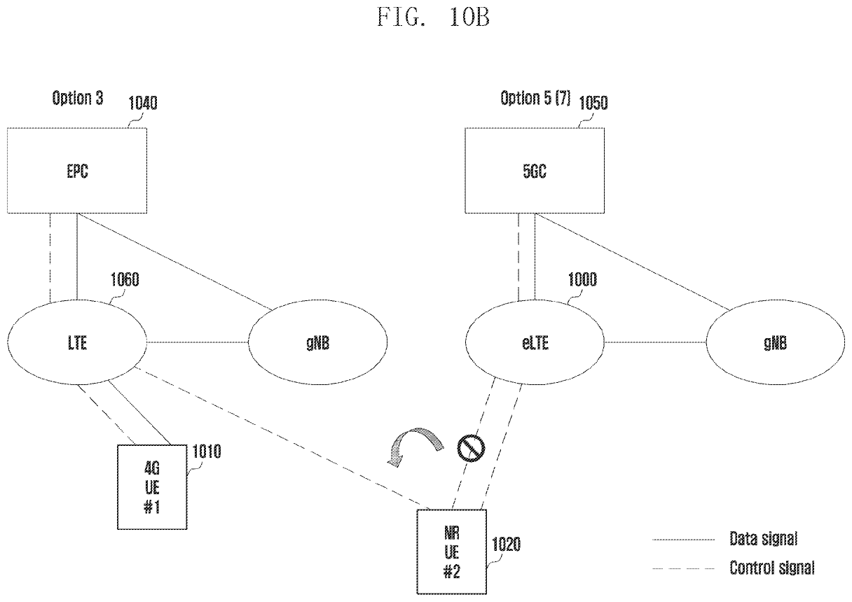

FIGS. 10A and 10B are diagrams illustrating a network arrangement according to various embodiments. Referring to FIGS. 10A and 10B, according to various embodiments, the network arrangement of option 3 and option 5 or option 7 may be combined.

According to various embodiments, an eLTE cell 1000 of option 5 or option 7 may be connected to an EPC 1040, which is a 4G core network, while simultaneously connected to a 5GC 1050, which is a 5G core network. According to another embodiment, the eLTE cell 1000 may be connected only to the 5GC 1050, which is a 5G core network.

An embodiment in which the eLTE cell 1000 is connected to the EPC 1040, which is a 4G core network, and is simultaneously connected to the 5GC 1050, which is a 5G core network, will be described with reference to FIG. 10A.

According to various embodiments, it is assumed that the electronic device 1 910 in FIG. 10A supports only 4G wireless communication. Further, it is assumed that the electronic device 2 1020 has camped on the eLTE cell 1000 by searching for 4G RAT, based on at least one of a combination of network deployment options supported by the electronic device 2 1020, preference, or information received from the network, while supporting 4G and 5G wireless communication.

According to various embodiments, the eLTE cell 1000 may transmit information indicating the type of a supported core network. For example, the eLTE cell 1000 may transmit information indicating that both the 5GC 1050 and the EPC 1040 are supported. For example, the eLTE cell 1000 may configure whether to support the EPC 1040 or the 5GC 1050 as bit values, respectively, and notify them through broadcasting information. For example, the eLTE cell 1000 may transmit that it supports both the 5GC 1050 and the EPC 1040 by configuring the “cellBarred flag” value in the transmitted SIB1 or configuring it as a value other than “cellBarred”.

According to various embodiments, in the case of the electronic device 1 1010 supporting only 4G wireless communication, when camping on the eLTE cell 1000, the electronic device 1 1010 may perform a 4G NAS procedure and register with the EPC 1040. According to various embodiments, the electronic device 2 1020 supporting 4G and 5G wireless communication may register with the EPC 1040 or 5GC 1050, based on the core network preference of the electronic device. For example, the electronic device 2 1020 may perform a 4G NAS procedure when the core network preference of the electronic device 2 1020 is the EPC 1040. According to another example, the electronic device 2 1020 may perform a 5G NAS procedure when the core network preference of the electronic device 2 1020 is 5GC 1050.

According to various embodiments, the core network preference of the electronic device may be determined based on the type of an application installed or running on the electronic device. For example, when there is an application requesting 5G service such as enhanced mobile broadband (eMBB), ultra-reliable and low latency communications (URLLC), etc. in the electronic device, or a user activates through a UI or the like to use at least one 5G service for an arbitrary application, the electronic device 2 1020 may determine the core network preference as 5GC 1050. Accordingly, the electronic device 2 1020 may perform a 5G NAS procedure with the 5GC 1050.

An embodiment in which the eLTE cell 1000 is connected only to the 5GC 1050, which is a 5G core network, will be described with reference to FIG. 10B.

According to various embodiments, the eLTE cell 1000 may transmit information indicating the type of a supported core network. For example, the eLTE cell 1000 may notify information that only 5GC 1050 is supported. For example, the eLTE cell 1000 may configure whether to support the EPC 1040 or the 5GC 1050 network as a bit value, and notify the same through broadcasting information. For example, the eLTE cell 1000 may configure, for example, the ‘cellBarred flag’ value as ‘cellBarred’ using the ‘cellBarred flag’ value in the transmitted SIB1 and transmit that only 5GC 1050 is supported. According to various embodiments, the electronic device 1 1010 supporting only 4G wireless communication may know that the eLTE cell 1000 supports only the 5GC 1050, based on the ‘cellBarred flag’ value of SIB 1 transmitted from the eLTE cell 1000. Accordingly, the electronic device 1 1010 supporting only 4G wireless communication cannot camp on the eLTE cell 1000. The electronic device 1 1010 may search for another 4G cell. For example, the electronic device 1 1010 may camp on the LTE cell 1060 and register with the EPC 1040 by performing a 4G NAS procedure.

According to various embodiments, the electronic device 2 1020 searching for the eLTE cell 1000 may perform a 5G NAS procedure. For example, the electronic device 2 1020 may identify that the eLTE cell 1000 supports the 5GC 1050 with the ‘cellBarred flag’ value in SIB 1 transmitted from the network, and may perform a 5G NAS procedure.

According to various embodiments, when it is determined that the electronic device 2 1020 is not subscribed to the 5G wireless communication service or the 5G wireless communication service is unnecessary, based on the service activated in the electronic device 2 1020, the electronic device 2 1020 may determine to camp on a 4G cell. The electronic device 2 1020 may process the eLTE cell 1000 as “cellbarred” and search for another cell.

According to various embodiments disclosed in this document as described above, in a network structure in which 4G communication and 5G communication are mixed, the electronic device (e.g., 101 of FIG. 1) may be connected to a 4G or 5G network, based on at least one of a wireless communication priority and a core network preference of the electronic device.

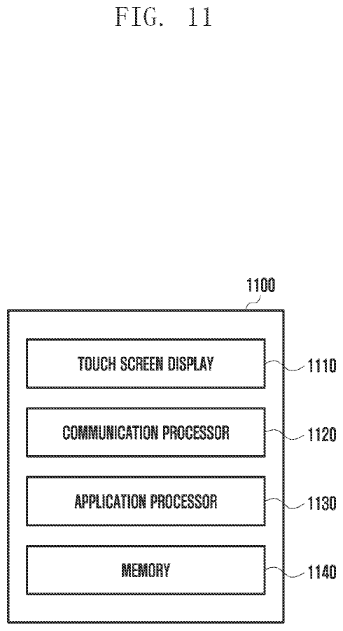

FIG. 11 is a block diagram illustrating a structure of an electronic device (e.g., 101 of FIG. 1) according to various embodiments disclosed in this document.

According to various embodiments, the electronic device 1100 (e.g., 101 of FIG. 1) may include a touch screen display 1110 (e.g., the display device 160 of FIG. 1), at least one communication processor 1120 (e.g., the secondary processor 123 or the wireless communication module 192 of FIG. 1), an application processor 1130 (e.g. the main processor of FIG. 1), and a memory 1140 (e.g., the memory 130 of FIG. 1).

According to various embodiments, the touch screen display 1110 (e.g., the display device 160 of FIG. 1) may visually provide information to the outside (e.g., a user) of the electronic device 101. For example, the touch screen display 1110 (e.g., the display device 160 of FIG. 1) may display a UI (e.g., 600 of FIG. 6). Further, the touch screen display 1110 (e.g., the display device 160 of FIG. 1) may receive an input signal from a user through the UI (e.g., 600 of FIG. 6).

According to various embodiments, at least one communication processor 1120 (e.g., the secondary processor 123 or the wireless communication module 192 of FIG. 1) may provide a first wireless communication using a first frequency range and a second wireless communication using a second frequency range higher than the first frequency range.

According to various embodiments, the application processor 1130 (e.g., the main processor 121 of FIG. 1) may be operatively connected to the touch screen display 1110 (e.g., the display device 160 of FIG. 1) and the at least one communication processor 1120 (e.g., the secondary processor 123 or the wireless communication module 192 of FIG. 1).

According to various embodiments, the memory 1140 (e.g., the memory 130 of FIG. 1) may store instructions. For example, the memory 1140 (e.g., the memory 130 of FIG. 1) may store instructions which enable, during execution, at least one communication processor 1120 (e.g., the secondary processor 123 or the wireless communication module 192 of FIG. 1) to receive information from at least one of the plurality of cells related to the first wireless communication, using the first wireless communication. For example, the memory 1140 (e.g., the memory 130 of FIG. 1) may store instructions which enable, during execution, at least one communication processor 1120 (e.g., the secondary processor 123 or the wireless communication module 192 of FIG. 1) to select one cell among the plurality of cells, based on at least a part of the information related to the plurality of cells. The memory 1140 (e.g., the memory 130 of FIG. 1) may store instructions which enable, during execution, at least one communication processor 1120 (e.g., the secondary processor 123 or the wireless communication module 192 of FIG. 1) to identify whether or not the selected cell is connected to a first core network and a second core network, based on at least a part of the information related to the selected cell. The memory 1140 (e.g., the memory 130 of FIG. 1) may store instructions which enable, during execution, at least one communication processor 1120 (e.g., the secondary processor 123 or the wireless communication module 192 of FIG. 1) to transmit, to one core network among the first core network and the second core network, a registration request message for using the one core network by means of the first wireless communication, based on at least a part of the stored network selection information.

According to various embodiments, the memory 1140 (e.g., the memory 130 of FIG. 1) may further store at least one piece of wireless communication priority information.

According to various embodiments, the memory 1140 (e.g., the memory 130 of FIG. 1) may store instructions which enable the at least one communication processor 1120 (e.g., the secondary processor 123 or the wireless communication module 192 of FIG. 1) to determine to use the first wireless communication, based on at least a portion of the wireless communication priority information and receive information related to the plurality of cells, based on the determination.

According to various embodiments, the memory 1140 (e.g., the memory 130 of FIG. 1) may store instructions which enable the at least one communication processor 1120 (e.g., the secondary processor 123 or the wireless communication module 192 of FIG. 1) to select public land mobile network (PLMN), and receive information related to the plurality of cells, based at least in part on priority information related to the selected PLMN among the wireless communication priority information.

According to various embodiments, the memory 1140 (e.g., the memory 130 of FIG. 1) may store instructions which enable the at least one communication processor 1120 (e.g., the secondary processor 123 or the wireless communication module 192 of FIG. 1) to receive at least one of system information block (SIB) using the first wireless communication. The at least one SIB includes information related to the plurality of cells. For example, at least a part of the SIB further includes information related to whether the first core network and/or the second core network are connected.

According to various embodiments, the first core network includes an evolved packet core (EPC) defined by the 3GPP standard, and the second core network includes a 5th generation (5G) core network defined by the 3GPP standard.

According to various embodiments, the memory 1140 (e.g., the memory 130 of FIG. 1) may store instructions which enable the application processor 1130 (e.g., the main processor 121 of FIG. 1) to determine at least a part of the network selection information, based on at least one application information being executed by the application processor or at least one application information installed in the memory, and at least temporarily store the network selection information in the memory.

According to various embodiments, the memory 1140 (e.g., the memory 130 of FIG. 1) may store instructions which enable the application processor 1130 (e.g., the main processor 121 of FIG. 1) to display a user interface on at least a portion of the display 1110 (e.g., the display device of FIG. 1), determine at least part of the network selection information, based at least in part on a user input received through the user interface, and at least temporarily store the network selection information in the memory.

According to various embodiments, the memory 1140 (e.g., the memory 130 of FIG. 1) may store instructions which enable the at least one communication processor 1120 (e.g., the secondary processor 123 or the wireless communication module 192 of FIG. 1) to transmit the registration request message to the second core network connected to the selected cell using the first wireless communication, and transmit a message indicating completion of registration to the application processor 1130 (e.g., the main processor 121 of FIG. 1), based at least in part on the registration approval message, when receiving a registration accept message from the second core network using the first wireless communication

According to various embodiments, the memory 1140 (e.g., the memory 130 of FIG. 1) may store instructions which enable the application processor 1130 (e.g., the main processor 121 of FIG. 1) to receive a message indicating completion of the registration, and display information related to the second core network on at least a portion of the display 1110 (e.g., the display device 160 of FIG. 1).

According to various embodiments, the memory 1140 (e.g., the memory 130 of FIG. 1) may store instructions which determine whether the terminal should use the second wireless communication based on information on at least one application being executed by the application processor 1130 (e.g., the main processor 121 of FIG. 1) or whether the terminal supports the second wireless communication service, when the selected cell is not connected to the first core network but is connected to the second core network, and enable the application processor 1130 (e.g., the main processor 121 of FIG. 1) to search for another cell connected to the first core network among the plurality of cells excluding the selected cell, when the at least one application being executed does not require the second wireless communication service or the terminal does not support the second wireless communication service, as a result of the determination. According to various embodiments, the electronic device 1100 (e.g., 101 of FIG. 1) may include a touch screen display 1110 (e.g., 160 of FIG. 1). In addition, the electronic device 1100 may include at least one communication processor 1120 (e.g., 190 of FIG. 1) configured to provide a first wireless communication using a first frequency range and a second wireless communication using a second frequency range higher than the first frequency range, an application processor 1130 (e.g., 120 of FIG. 1) operatively connected to the display 1110 and the at least one communication processor 1120, and at least one memory 1140 (e.g., 130 of FIG. 1) operatively connected to the communication processor 1120 and/or the application processor 1130 and configured to store network selection information.

According to various embodiments, the memory 1140 may store instructions which enable, when executed, the at least one communication processor 1120 to: receive information related to the plurality of cells from at least one of the plurality of cells related to the first wireless communication using the first wireless communication; select one cell among the plurality of cells, based on at least some of the information related to the plurality of cells; identify whether the selected cell is connected to a first core network and a second core network, based on at least part of the information related to the selected cell; and transmit a registration request message for use of the one core network to one core network among the first core network or the second core network using the first wireless communication, based at least in part on the stored network selection information.

According to various embodiments, the memory 1140 may further store at least one piece of wireless communication priority information.

According to various embodiments, the instructions may enable the at least one communication processor 1120 to determine to use the first wireless communication, based on at least a portion of the wireless communication priority information and receive information related to the plurality of cells, based on the determination.

According to various embodiments, the instructions may enable the at least one communication processor 1120 to select public land mobile network (PLMN), and receive information related to the plurality of cells, based at least in part on priority information related to the selected PLMN among the wireless communication priority information.

According to various embodiments, the instructions may enable the at least one communication processor 1120 to receive at least one of system information block (SIB) using the first wireless communication, and the at least one SIB may include information related to the plurality of cells.

According to various embodiments, at least a part of the SIB further includes information related to whether the first core network and/or the second core network are connected.

According to various embodiments, the first core network may include an evolved packet core (EPC) defined by the 3GPP standard, and the second core network may include a 5th generation (5G) core network defined by the 3GPP standard.

According to various embodiments, the instructions may enable, when executed, the application processor 1130 to determine at least a part of the network selection information, based on at least one application information being executed by the application processor or at least one application information installed in the memory 1140, and at least temporarily store the network selection information in the memory 1140.

According to various embodiments, the instructions may enable the application processor 1130 to display a user interface on at least a portion of the display 1110, determine at least part of the network selection information, based at least in part on a user input received through the user interface, and at least temporarily store the network selection information in the memory 1140.

According to various embodiments, the instructions may enable the at least one communication processor 1120 to transmit the registration request message to the second core network connected to the selected cell using the first wireless communication, and transmit a message indicating completion of registration to the application processor, based at least in part on the registration approval message, when receiving a registration accept message from the second core network using the first wireless communication

According to various embodiments, the instructions may enable the application processor 1130 to receive a message indicating completion of the registration, and display information related to the second core network on at least a portion of the display 1110.

According to various embodiments, the instructions may enable to determine whether the terminal should use the second wireless communication based on information on at least one application being executed by the application processor or whether the terminal supports the second wireless communication service, when the selected cell is not connected to the first core network but is connected to the second core network, and enable the application processor to search for another cell connected to the first core network among the plurality of cells excluding the selected cell, when the at least one application being executed does not require the second wireless communication service or the terminal does not support the second wireless communication service, as a result of the determination.

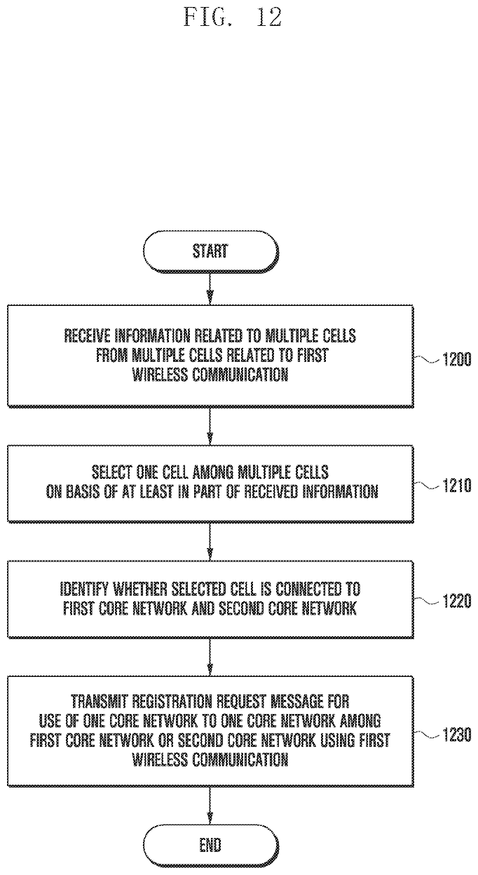

FIG. 12 is a flowchart illustrating a method of controlling an electronic device (e.g., 101 of FIG. 1) according to various embodiments.

According to various embodiments, operations 1200 to 1230 may be executed through one of an electronic device (e.g., 101 of FIG. 1), a processor (e.g., 120 of FIG. 1), a main processor (or application processor) (e.g., 121 of FIG. 1), or a secondary processor (e.g., communication processor (e.g., 123 of FIG. 1) or wireless communication module (e.g., 192 of FIG. 1)).

According to various embodiments, in operation 1200, the electronic device (e.g., 101 of FIG. 1) may receive information related to the plurality of cells from at least one of the plurality of cells related to the first wireless communication. For example, the electronic device (e.g., 101 of FIG. 1) may receive information related to the plurality of cells from at least one of the plurality of cells related to the first wireless communication using the first wireless communication by at least one communication processor configured to provide a first wireless communication using a first frequency range and a second wireless communication using a second frequency range higher than the first frequency range.

According to various embodiments, in operation 1210, the electronic device (e.g., 101 of FIG. 1) may select one cell from among the plurality of cells based on at least a portion of the received information.

According to various embodiments, in operation 1220, the electronic device (e.g., 101 of FIG. 1) may identify whether the selected cell is connected to the first core network and the second core network. For example, the electronic device (e.g., 101 of FIG. 1) may identify whether the selected cell is connected to a first core network (e.g., EPC) and a second core network (e.g., 5GC), based on at least a portion of the information related to the selected cell.

According to various embodiments, in operation 1230, the electronic device (e.g., 101 of FIG. 1) may transmit a registration request message for use of the one core network to one core network among the first core network or the second core network by using the first wireless communication, based at least in part on the stored network selection information.

According to various embodiments, the control method of the electronic device (e.g., 101 of FIG. 1) may further include: storing at least one wireless communication priority information; determining to use the first wireless communication, based on at least a portion of the wireless communication priority information; and receiving information related to the plurality of cells, based on the determination.

According to various embodiments, the control method of the electronic device (e.g., 101 of FIG. 1) may further include: selecting a public land mobile network (PLMN) by the at least one communication processor; and receiving information related to the plurality of cells, based at least in part on priority information related to the selected PLMN from the wireless communication priority information.

According to various embodiments, the control method of the electronic device (e.g., 101 of FIG. 1) may further include receiving at least one of system information block (SIB) using the first wireless communication, by the at least one communication processor, and the at least one SIB includes information related to the plurality of cells.

According to various embodiments, the at least a portion of the SIB further may further include information related to whether the first core network and/or the second core network is connected.

According to various embodiments, the first core network may include an evolved packet core (EPC) defined by the 3GPP standard, and the second core network may include a 5th generation (5G) core network defined by the 3GPP standard.

According to various embodiments, the control method of the electronic device (e.g., 101 of FIG. 1) may further include: determining at least a part of the network selection information, based on at least one application information being executed by the application processor or at least one application information installed in the memory; and at least temporarily storing the network selection information in the memory.

According to various embodiments, the control method of the electronic device (e.g., 101 of FIG. 1) may further include: displaying a user interface on at least a portion of the display; determining at least a portion of the network selection information, based at least in part on a user input received through the user interface; and at least temporarily storing the network selection information in a memory.

According to various embodiments, the control method of the electronic device (e.g., 101 of FIG. 1) may further include: transmitting the registration request message to the second core network connected to the selected cell using the first wireless communication; and transmit a message indicating completion of registration, based at least in part on the registration approval message, when receiving a registration accept message from the second core network using the first wireless communication.

According to various embodiments, the control method of the electronic device (e.g., 101 of FIG. 1) may further include: receiving a message indicating completion of the registration; and displaying information related to the second core network on at least a portion of the display

According to various embodiments, the control method of the electronic device (e.g., 101 of FIG. 1) may further include determining whether the terminal should use the second wireless communication, based on information on at least one application being executed by the application processor or whether the terminal supports the second wireless communication service, when the selected cell is not connected to the first core network but is connected to the second core network; and searching for another cell connected to the first core network among the plurality of cells excluding the selected cell, when the at least one application being executed does not require the second wireless communication service, or the terminal does not support the second wireless communication service, as a result of the determination.

According to various embodiments disclosed in this document, in a network structure in which 4G communication and 5G communication are mixed, an electronic device (e.g., 101 of FIG. 1) may be connected to a 4G or 5G network, based on at least one of a wireless communication priority or a core network preference of the electronic device.

1. An electronic device comprising:
a touch screen display;
at least one communication processor configured to provide a first wireless communication using a first frequency range and a second wireless communication using a second frequency range higher than the first frequency range;
an application processor operatively connected to the display and the at least one communication processor; and
at least one memory operatively connected to the communication processor and/or the application processor, and configured to store network selection information,
wherein the memory, when executed, stores instructions to enable the at least one communication processor to:
receive information related to the plurality of cells from at least one of the plurality of cells related to the first wireless communication using the first wireless communication;
select one cell among the plurality of cells, based on at least some of the information related to the plurality of cells;
identify whether the selected cell is connected to a first core network and a second core network, based on at least part of the information related to the selected cell; and
transmit, to one core network among the first core network or the second core network, a registration request message for using the one core network using the first wireless communication, based on at least in part of the stored network selection information.

2. The electronic device of claim 1,
wherein the memory further stores at least one piece of wireless communication priority information,
wherein the instructions enable the at least one communication processor to:
determine to use the first wireless communication, based on at least a portion of the wireless communication priority information; and
receive information related to the plurality of cells, based on the determination,
wherein the instructions cause the at least one communication processor to:
select public land mobile network (PLMN); and
receive information related to the plurality of cells, based at least in part on priority information related to the selected PLMN among the wireless communication priority information.

3. The electronic device of claim 1, wherein the instructions enable the at least one communication processor to receive at least one of system information block (SIB) using the first wireless communication,
wherein the at least one SIB includes information related to the plurality of cells, and
wherein at least a part of the SIB further includes information related to whether the first core network and/or the second core network are connected.

4. The electronic device of claim 1, wherein the first core network includes an evolved packet core (EPC) defined by the 3GPP standard, and the second core network includes a 5th generation (5G) core network defined by the 3GPP standard,
wherein the instructions enable the application processor to:
determine at least a part of the network selection information, based on at least one application information being executed by the application processor or at least one application information installed in the memory; and
at least temporarily store the network selection information in the memory.

5. The electronic device of claim 1, wherein the instructions enable the application processor to:
display a user interface on at least a portion of the display;
determine at least part of the network selection information, based at least in part on a user input received through the user interface; and
at least temporarily store the network selection information in the memory,
wherein the instructions enable the at least one communication processor to:
transmit the registration request message to the second core network connected to the selected cell using the first wireless communication; and
transmit a message indicating completion of registration to the application processor, based at least in part on the registration approval message, when receiving a registration accept message from the second core network using the first wireless communication,
wherein the instructions determine whether the terminal should use the second wireless communication, based on information on at least one application being executed by the application processor or whether the terminal supports the second wireless communication service, when the selected cell is not connected to the first core network but is connected to the second core network, and
wherein, as a result of the determination, when the at least one application being executed does not require the second wireless communication service, or the terminal does not support the second wireless communication service, the instructions cause the application processor to search for another cell connected to the first core network among the plurality of cells excluding the selected cell.

6. A control method of an electronic device, the control method comprising:
receiving information related to a plurality of cells from at least one of the plurality of cells related to a first wireless communication using the first wireless communication, by at least one communication processor configured to provide the first wireless communication using a first frequency range and a second wireless communication using a second frequency range higher than the first frequency range;
selecting one of the plurality of cells, based on at least some pieces of the information related to the plurality of cells;
identifying whether the selected cell is connected to a first core network and a second core network, based on at least part of the information related to the selected cell; and
transmitting a registration request message for use of the one core network to one of the first core network and the second core network by using the first wireless communication, based at least in part on the stored network selection information.

7. The control method of claim 6, further comprising:
further storing at least one wireless communication priority information;
determining to use the first wireless communication, based on at least a portion of the wireless communication priority information; and
receiving information related to the plurality of cells, based on the determination.

8. The control method of claim 7, further comprising:
selecting a public land mobile network (PLMN) by the at least one communication processor; and
receiving information related to the plurality of cells, based at least in part on priority information related to the selected PLMN from the wireless communication priority information.

9. The control method of claim 6, further comprising receiving at least one of system information block (SIB) using the first wireless communication, by the at least one communication processor,
wherein the at least one SIB includes information related to the plurality of cells.

10. The control method of claim 9, wherein at least a portion of the SIB further includes information related to whether the first core network and/or the second core network is connected.

11. The control method of claim 6, wherein the first core network includes an evolved packet core (EPC) defined by the 3GPP standard, and the second core network includes a 5th generation (5G) core network defined by the 3GPP standard.

12. The control method of claim 6, further comprising:
determining at least a part of the network selection information, based on at least one application information being executed by the application processor or at least one application information installed in the memory; and
at least temporarily storing the network selection information in the memory.

13. The control method of claim 6, further comprising:
displaying a user interface on at least a portion of the display;
determining at least a portion of the network selection information, based at least in part on a user input received through the user interface; and
at least temporarily storing the network selection information in a memory.

14. The control method of claim 6, further comprising:
transmitting the registration request message to the second core network connected to the selected cell using the first wireless communication; and
transmitting a message indicating completion of registration, based at least in part on the registration approval message, when receiving a registration accept message from the second core network using the first wireless communication

15. The control method of claim 6, further comprising:
determining whether the terminal should use the second wireless communication, based on information on at least one application being executed by the application processor or whether the terminal supports the second wireless communication service, when the selected cell is not connected to the first core network but is connected to the second core network, and
searching for another cell connected to the first core network among the plurality of cells excluding the selected cell, when the at least one application being executed does not require the second wireless communication service, or the terminal does not support the second wireless communication service, as a result of the determination.
